(19) United States
(12) Patent Application Publication
(10) Pub. No.: US 2019/0147265 A1
(43) Pub. Date: May 16, 2019

(54) DISTRACTED DRIVING DETERMINATION APPARATUS, DISTRACTED DRIVING DETERMINATION METHOD, AND PROGRAM FOR DISTRACTED DRIVING DETERMINATION

(71) Applicant: OMRON Corporation, Kyoto-shi (JP)

(72) Inventors: Tomoyoshi AIZAWA, Kyoto-shi (JP); Tadashi HYUGA, Hirakata-shi (JP); Hatsumi AOI, Kyotanabe-shi (JP); Yoshio MATSUURA, Kasugai-shi (JP); Masato TANAKA, Kizugawa-shi (JP); Keisuke YOKOTA, Kasugai-shi (JP); Hisashi SAITO, Kasugai-shi (JP)

(73) Assignee: OMRON Corporation, Kyoto-shi (JP)

(21) Appl. No.: 16/143,367

(22) Filed: Sep. 26, 2018

(30) Foreign Application Priority Data
Nov. 15, 2017 (JP) 2017-219844

(51) Int. Cl. G06K 9/00; B60Q 9/00

(52) U.S. Cl. CPC G06K 9/00845; G06K 9/00993; G06K 9/00228; B60Q 9/00

(57) ABSTRACT

Distracted driving determination reflects changes in a vehicle traveling direction. A distracted driving determination apparatus includes a first obtaining unit that obtains first information indicating a driver's gaze or face orientation, a first determiner that determines whether the driver is engaging in distracted driving based on the gaze or face orientation indicated by the first information and a determination condition for detecting distracted driving, a second obtaining unit that obtains second information indicating a change in a traveling direction of a vehicle with respect to a straight traveling direction of the vehicle, a second determiner that determines whether the vehicle is traveling straight or traveling rightward or leftward based on the second information, and a condition changer that sets the determination condition to a first condition when the vehicle is traveling straight, and to a second condition different from the first condition when the vehicle is traveling rightward or leftward.

### CROSS-REFERENCE TO RELATED APPLICATION

This application claims priority to Japanese Patent Application No. 2017-219844 filed on Nov. 15, 2017, the entire disclosure of which is incorporated herein by reference.

### FIELD

The present invention relates to a distracted driving determination apparatus that determines distracted driving of a vehicle driver, a distracted driving determination method, and a program for distracted driving determination.

### BACKGROUND

Techniques have been developed to determine distracted driving of a driver by capturing an image of the face of the driver and determining his or her face orientation with an image processor, as one such example is described in Patent Literature 1. The technique described in Patent Literature 1 changes the detection sensitivity of distracted driving depending on the vehicle state.

### CITATION LIST

### Patent Literature

Patent Literature 1: Japanese Unexamined Patent Application Publication No. 2001-138767

### SUMMARY

### Technical Problem

The direction of the driver's intended gaze changes typically depending on the traveling state of the vehicle. The action of the driver looking in a specific direction can be distracted driving in one traveling state of the vehicle, or may not be distracted driving and may rather be an intended gaze in another traveling state of the vehicle.

However, the technique described in Patent Literature 1 does not change the conditions for detecting distracted driving depending on the traveling state of the vehicle.

In response to the above issue, one or more aspects of the present invention are directed to a technique for determining distracted driving while reflecting changes in the traveling direction of the vehicle.

### Solution to Problem

A distracted driving determination apparatus according to a first aspect of the disclosure includes a first obtaining unit that obtains first detection information indicating a gaze or a face orientation of a driver, a first determiner that determines whether the driver is engaging in distracted driving based on the gaze or the face orientation of the driver indicated by the first detection information and a determination condition for detecting distracted driving, a second obtaining unit that obtains second detection information indicating a change in a traveling direction of a vehicle with respect to a straight traveling direction of the vehicle, a second determiner that determines whether the vehicle is traveling straight or traveling rightward or leftward based on the second detection information, and a condition changer that sets the determination condition to a first determination condition when the vehicle is determined to be traveling straight based on a determination result from the second determiner, and to a second determination condition different from the first determination condition when the vehicle is determined to be traveling rightward or leftward based on the determination result from the second determiner.

The distracted driving determination apparatus according to the first aspect determines distracted driving based on the gaze or the face orientation of the driver and the first determination condition when the vehicle is determined to be traveling straight, and determines distracted driving based on the gaze or the face orientation of the driver and the second determination condition different from the first determination condition when the vehicle is determined to be traveling rightward or leftward. The apparatus according the first aspect enables distracted driving determination reflecting changes in the traveling direction of the vehicle.

A distracted driving determination apparatus according to a second aspect of the disclosure is the distracted driving determination apparatus according to the first aspect in which the second determination condition is set to a different value between when the vehicle is determined to be traveling rightward based on the determination result from the second determiner and when the vehicle is determined to be traveling leftward based on the determination result from the second determiner.

The distracted driving determination apparatus according to the second aspect determines distracted driving using different determination conditions when the vehicle is traveling rightward and when the vehicle is traveling leftward. This structure enables distracted driving determination using determination conditions appropriately set for right turning and left turning.

A distracted driving determination apparatus according to a third aspect of the disclosure is the distracted driving determination apparatus according to the first or second aspect in which the condition changer defines, as the first determination condition, a first area that is an imaginary area ranging toward a front of the vehicle at a first angle and a second area that is an imaginary area adjacent to the first area and ranging toward a right or left of the vehicle at a second angle. The condition changer defines, as the second determination condition, a third area that is an imaginary area ranging toward the front of the vehicle at a third angle greater than the first angle and a fourth area that is an imaginary area adjacent to the first area and ranging toward the right or left of the vehicle at a fourth angle smaller than the second angle. The first determiner determines that the driver is not engaging in distracted driving when the gaze or the face orientation of the driver is within the first area or the third area. The first determiner determines that the driver is engaging in distracted driving when the gaze or the face orientation of the driver is within the second area or the fourth area.

When the vehicle is traveling straight, the distracted driving determination apparatus according to the third aspect determines distracted driving by determining whether the gaze or the face orientation of the driver is within the first area defined using the first angle and the second area defined using the second angle. When the vehicle is traveling rightward or leftward, the distracted driving determination apparatus determines distracted driving by determining whether the gaze or the face orientation of the driver is within the third area defined using the angle greater than the first angle and the fourth area defined using the angle smaller than the second angle. When the vehicle is traveling rightward or leftward, distracted driving is less likely to be detected than when the vehicle is travelling straight. This structure thus reduces erroneous determination in which the action of safety checking performed by the driver to the right or left to, for example, turn right, turn left, change the lane, or pull over to the side of a road is determined to be distracted driving.

A distracted driving determination apparatus according to a fourth aspect of the disclosure is the distracted driving determination apparatus according to the third aspect in which the condition changer sets the third angle to a greater value and sets the fourth angle to a smaller value as a quantity of change in the traveling direction of the vehicle obtained from the second obtaining unit increases.

The distracted driving determination apparatus according to the fourth aspect sets the third angle and the fourth angle variably in accordance with the quantity of change in the traveling direction of the vehicle. When turning right or left, for example, the driver is typically likely to direct his or her gaze or face to the left rear rather than the left front and to the right rear rather than the right front of the vehicle as changing the traveling direction of the vehicle rightward or leftward greatly with respect to the straight traveling direction of the vehicle. The apparatus thus changes the angles of the areas used for distracted driving determination in accordance with the quantity of change in the traveling direction of the vehicle as described above to prevent intended checking to the right or left from being inappropriately determined to be distracted driving.

A distracted driving determination apparatus according to a fifth aspect of the disclosure is the distracted driving determination apparatus according the first or second aspect in which the condition changer defines a distracted driving determination area that is an imaginary area defined at the right or the left of the vehicle for determining distracted driving. The condition changer sets, as the first determination condition, a first duration for which the gaze or the face orientation of the driver is allowed to be within the distracted driving determination area. The condition changer sets, as the second determination condition, a second duration longer than the first duration. The first determiner determines that the driver is not engaging in distracted driving when the gaze or the face orientation of the driver is continuously within the distracted driving determination area for a duration less than or equal to the first duration or the second duration. The first determiner determines that the driver is engaging in distracted driving when the gaze or the face orientation of the driver continuously is within the distracted driving determination area for a duration exceeding the first duration or the second duration.

The distracted driving determination apparatus according to the fifth aspect detects distracted driving when the gaze or the face orientation of the driver is within the distracted driving determination area for more than the first duration when the vehicle is traveling straight. In contrast, the distracted driving determination apparatus does not detect distracted driving until the gaze or the face orientation is within the distracted driving determination area for more than the second duration, which is longer than the first duration, when the vehicle is traveling rightward or leftward. When the vehicle is traveling rightward or leftward, distracted driving is less likely to be detected than when the vehicle is travelling straight. This structure thus reduces erroneous determination in which the checking action of the driver to the right or left to, for example, turn right, turn left, change the lane, or pull over to the side of a road is determined to be distracted driving.

A distracted driving determination apparatus according to a sixth aspect of the disclosure is the distracted driving determination apparatus according the fifth aspect in which the condition changer sets the second duration to a greater value as the quantity of change in the traveling direction of the vehicle obtained from the second obtaining unit increases.

The distracted driving determination apparatus according to the sixth aspect sets the second duration for which distracted driving is allowed variably in accordance with the quantity of change in the traveling direction of the vehicle. When turning right or left, for example, the driver is typically likely to change his or her gaze or face orientation greatly as the operational quantity of the steering wheel increases. After changing his or her gaze or face orientation greatly as described above, the driver may take a longer time to change the gaze or the face orientation back to the front. The apparatus thus changes the allowable duration for distracted driving in accordance with the quantity of change in the traveling direction of the vehicle as described above to prevent intended checking to the right or left from inappropriately being determined to be distracted driving.

A distracted driving determination apparatus according to a seventh aspect of the disclosure is the distracted driving determination apparatus according to any one of the first to sixth aspects further including a third obtaining unit that obtains third detection information indicating a traveling state of the vehicle, and a fourth determiner that determines whether the vehicle is at a speed greater than or equal to a predetermined speed at which the vehicle is determined to be traveling or at a speed less than the predetermined speed at which the vehicle is determined as being stopped. The condition changer sets the determination condition to the first determination condition when the vehicle is determined as being stopped based on a determination result from the fourth determiner, irrespective of whether the vehicle is determined to be traveling rightward or leftward.

The distracted driving determination apparatus according to the seventh aspect sets, when the vehicle is stopped before, for example, turning right or left, the first determination condition used in traveling straight rather than the second determination condition used in turning right or left. This allows the driver to direct his or her gaze or face forward rather than rightward or leftward from the vehicle when the vehicle is stopped with its traveling direction being changed rightward or leftward with respect to the straight traveling direction to wait for, for example, pedestrians to cross the road or for a traffic signal to change.

A distracted driving determination apparatus according to an eighth aspect of the disclosure further includes an output unit that outputs an instruction signal to a support apparatus to support the driver when the first determiner determines that the driver is engaging in distracted driving.

The distracted driving determination apparatus according to the eighth aspect outputs the instruction signal to the support apparatus to support the driver when the driver is determined to be engaging in distracted driving. This structure allows the driver engaging in distracted driving to receive driving support from the support apparatus, thus effectively reducing distracted driving.

A distracted driving determination apparatus according to a ninth aspect of the disclosure includes a first obtaining unit that obtains first information indicating a gaze or a face orientation of a driver, a second obtaining unit that obtains second information indicating a traveling direction of a vehicle, and a determiner that determines distracted driving by comparing the gaze or the face orientation indicated by the first information with a predetermined criterion indicating a direction or a duration. The determiner changes the criterion in accordance with the traveling direction indicated by the second information.

The distracted driving determination apparatus according to the ninth aspect determines distracted driving by comparing the gaze or the face orientation of the driver with the predetermined criterion indicating the direction or the duration, in which the criterion is changed in accordance with the traveling direction of the vehicle. This enables distracted driving determination reflecting changes in the traveling direction of the vehicle.

### Advantageous Effects

One or more aspects of the present invention provide a technique enabling distracted driving determination reflecting changes in the traveling direction of the vehicle.

### BRIEF DESCRIPTION OF THE DRAWINGS

FIG. 1 is a schematic diagram describing an example use of a distracted driving determination apparatus according to an embodiment.

FIG. 2 is a schematic diagram of a vehicle including the distracted driving determination apparatus according to the present embodiment showing its overall structure.

FIG. 3 is a block diagram of the distracted driving determination apparatus according to the present embodiment showing its hardware configuration.

FIG. 4 is a schematic diagram describing a usual driving determination condition.

FIG. 5 is a block diagram of the distracted driving determination apparatus according to the present embodiment showing its software configuration.

FIG. 6A is a schematic diagram describing a left determination condition.

FIG. 6B is a schematic diagram describing a left determination condition.

FIG. 6C is a schematic diagram describing a left determination condition.

FIG. 7A is a schematic diagram describing a right determination condition.

FIG. 7B is a schematic diagram describing a right determination condition.

FIG. 7C is a schematic diagram describing a right determination condition.

FIG. 8 is a flowchart showing distracted driving determination performed by the distracted driving determination apparatus according to the present embodiment.

FIG. 9 is a flowchart showing an example operation for relaxing a determination condition performed by the distracted driving determination apparatus according to the present embodiment.

FIG. 10 is a flowchart showing another example operation for relaxing a determination condition performed by the distracted driving determination apparatus according to the present embodiment.

### DETAILED DESCRIPTION

An embodiment of the present disclosure (hereafter, the present embodiment) will now be described with reference to the drawings. The present embodiment described below is a mere example in any aspect. The same or similar components as already described are given the same or similar reference numerals, and will not be described repeatedly. Although data used in the present embodiment is described in a natural language, such data may be specifically defined using a pseudo language, a command, a parameter, or a machine language.

### 1. Example Use

A distracted driving determination apparatus according to the present embodiment determines whether a driver is engaging in distracted driving based on the gaze or face orientation of the driver and a determination condition for detecting distracted driving. The apparatus determines whether the vehicle is traveling straight or traveling rightward or leftward. When determining that the vehicle is traveling straight, the apparatus sets the determination condition to a first determination condition. When determining that the vehicle is traveling rightward or leftward, the apparatus sets the determination condition to a second determination condition different from the first determination condition. More specifically, the above second determination condition is set to a value with which distracted driving is less likely to be detected than under the first determination condition.

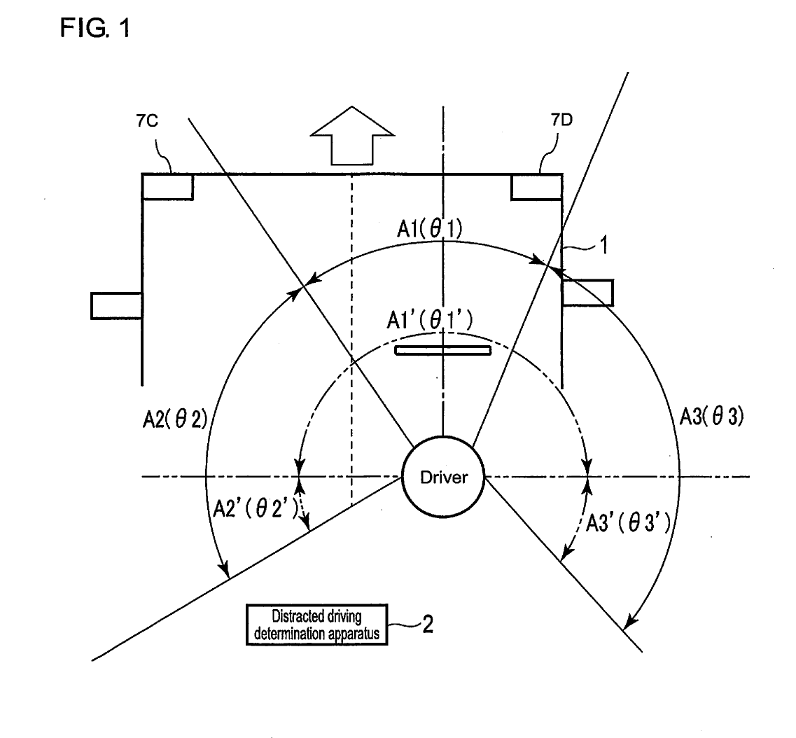

FIG. 1 is a schematic diagram describing an example use of a distracted driving determination apparatus 2, which is mounted on a vehicle 1. FIG. 1 shows the vehicle 1 as viewed from above. The radial solid lines indicate imaginary areas A1, A2, and A3 defined when the vehicle 1 is traveling straight along a road. The two-dot chain lines indicate imaginary areas A1′, A2′, and A3′ defined when the vehicle 1 is changing the traveling direction rightward or leftward. The broken line indicates the centerline in the width direction of the vehicle 1, and the dot-and-dash line indicates the straight traveling direction of the vehicle 1. Although FIG. 1 shows the vehicle with a right-hand steering wheel, the present embodiment is applicable to a vehicle with a left-hand steering wheel.

The first area A1 is an imaginary area horizontally ranging from the driver toward the front of the vehicle 1 at a first angle θ1. The first area A1 is defined as an area in which the driver is determined not to be engaging in distracted driving. The second area A2 is an imaginary area adjacent to the first area A1 and horizontally ranging from the driver toward the left of the vehicle 1 at a second angle θ2. The second area A2 is associated with a first duration for which the gaze or face orientation of the driver is allowed to be retained. The third area A3 is an imaginary area adjacent to the first area A1 and horizontally ranging from the driver toward the right of the vehicle 1 at a third angle θ3. The third area A3 is associated with a second duration for which the gaze or face orientation of the driver is allowed to be retained.

Retention of the gaze or face orientation described above equates to the gaze or face orientation residing within a predetermined area, or in other words, detecting the gaze or face orientation directed continuously in one of the above areas for a predetermined duration, or detecting the gaze or face orientation residing continuously within a predetermined area for a predetermined duration.

The distracted driving determination apparatus 2 determines whether the vehicle is traveling straight or traveling rightward or leftward based on, for example, the steering angle of the steering wheel. The vehicle traveling straight includes the direction in which the steering angle varies within a predetermined angle range, such as when the vehicle is traveling along a curved road. The traveling direction of the vehicle may also be determined by detecting the traveling direction of the vehicle based on the angles of the tires or using a gyroscope.

When determining that the vehicle is traveling straight based on the above detection result indicating the traveling direction of the vehicle, the distracted driving determination apparatus 2 sets the first area A1 to the first angle θ1, the second area A2 to the second angle θ2, and the third area A3 to the third angle θ3 as a distracted driving determination condition. This is referred to as a first determination condition. When determining that the vehicle is traveling rightward or leftward, the distracted driving determination apparatus 2 changes the angle of the first area A1 to the angle θ1 larger than the first angle θ1, the angle of the second area A2 to the angle θ2′ smaller than the second angle θ2, and the angle of the third area A3 to the angle θ3′ smaller than the third angle θ3 as a distracted driving determination condition as shown in FIG. 1. This is referred to as a second determination condition. The angles θ1, θ2, and θ3 are changed to the angles θ1′, θ2′, and θ3′ by, for example, shifting the boundary between the first area A1 and the second area A2, and the boundary between the first area A1 and the third area A3.

The distracted driving determination apparatus 2 obtains detection information indicating the gaze or face orientation of the driver from a gaze detector (not shown). Based on the detection information, the distracted driving determination apparatus 2 determines distracted driving by determining one of the areas A1, A2, and A3 or one of the areas A1′, A2′, or A3′ in which the gaze or face orientation of the driver is retained.

When, for example, the gaze or face orientation of the driver is within the first area A1 or A1′, the distracted driving determination apparatus 2 determines that the driver is not engaging in distracted driving irrespective of the retention allowable duration. When the gaze or face orientation of the driver is retained continuously within the second area A2 or A2′ for more than the first duration, or retained within the area, the distracted driving determination apparatus 2 determines that the driver is engaging in distracted driving. Similarly, when the gaze or face orientation of the driver is continuously within the third area A3 or A3′ for more than the second duration, the distracted driving determination apparatus 2 determines that the driver is engaging in distracted driving.

For this structure, the first determination condition is first set as the condition for determining distracted driving when the vehicle is traveling straight. Under this condition, once the gaze or face orientation of the driver is retained within the second area A2 for more than the first duration or is retained within the third area A3 for more than the second duration, the distracted driving determination apparatus 2 determines that the driver is engaging in distracted driving.

When the driver operates the steering wheel to, for example, turn right or left, the distracted driving determination apparatus 2 determines that the vehicle is changing the traveling direction rightward or leftward based on the steering angle. In this case, the distracted driving determination condition is changed from the first determination condition to the second determination condition. When, for example, the vehicle is turning left, the driver may direct his or her gaze or face leftward, and the retention allowable duration may exceed the first duration. However, the distracted driving determination apparatus 2 determines that the driver is not engaging in distracted driving when the gaze or face orientation is within the first area A1′ set after the change. Similarly, when, for example, the vehicle is turning right, the driver may gaze and direct his or her face rightward, and the retention allowable duration may exceed the second duration. However, the distracted driving determination apparatus 2 determines that the driver is not engaging in distracted driving when the gaze or face orientation is within the first area A1′ set after the change.

When the vehicle is traveling rightward or leftward, distracted driving is less likely to be detected than when the vehicle is travelling straight. This structure thus reduces erroneous determination in which the checking action of the driver to the right or left to, for example, turn right, turn left, change the lane, or pull over to the side of a road is determined to be distracted driving.

In turning right or left, however, the distracted driving determination apparatus 2 may determine that the driver is engaging in distracted driving when, for example, the gaze or the face of the driver is directed greatly rightward or leftward to the rear of the vehicle and retained within the second area A2′ for more than the first duration or within the third area A3′ for more than the second duration set after the change. The distracted driving determination apparatus 2 may thus determine that the driver is engaging in distracted driving when the driver changes his or her gaze or face orientation greatly.

In other words, the distracted driving determination apparatus according to the present embodiment enables distracted driving determination reflecting the traveling direction of the vehicle.

Although the distracted driving determination process is performed for both the right and left in the present embodiment, the process may be performed for either direction.

In the present embodiment, the first determination condition is defined by the angles θ1, θ2, and θ3 of the first, second, and third areas A1, A2, and A3 when the vehicle is traveling straight. The second determination condition is defined by the angles θ1′ θ2′, and θ3′ of the first, second, and third areas A1, A2, and A3 when the vehicle is changing the traveling direction rightward or leftward.

The above embodiment is not restrictive. The angles θ1, θ2, and θ3 of the first, second, and third areas may not be changed, but the first duration or the second duration, which indicates the retention allowable duration for the gaze and face orientation may be changed for the second area A2 and the third area A3. When, for example, the vehicle is traveling rightward or leftward, the first duration for the second area A2 and the second duration for the third area A3 are set longer than when the vehicle is travelling straight.

This structure detects distracted driving with a lower likelihood when the vehicle is traveling rightward or leftward than when the vehicle is travelling straight. This structure thus reduces erroneous determination in which the checking action of the driver to the right or left to, for example, turn right, turn left, change the lane, or pull over to the side of a road is determined to be distracted driving.

### 2. Example Configuration

### Vehicle

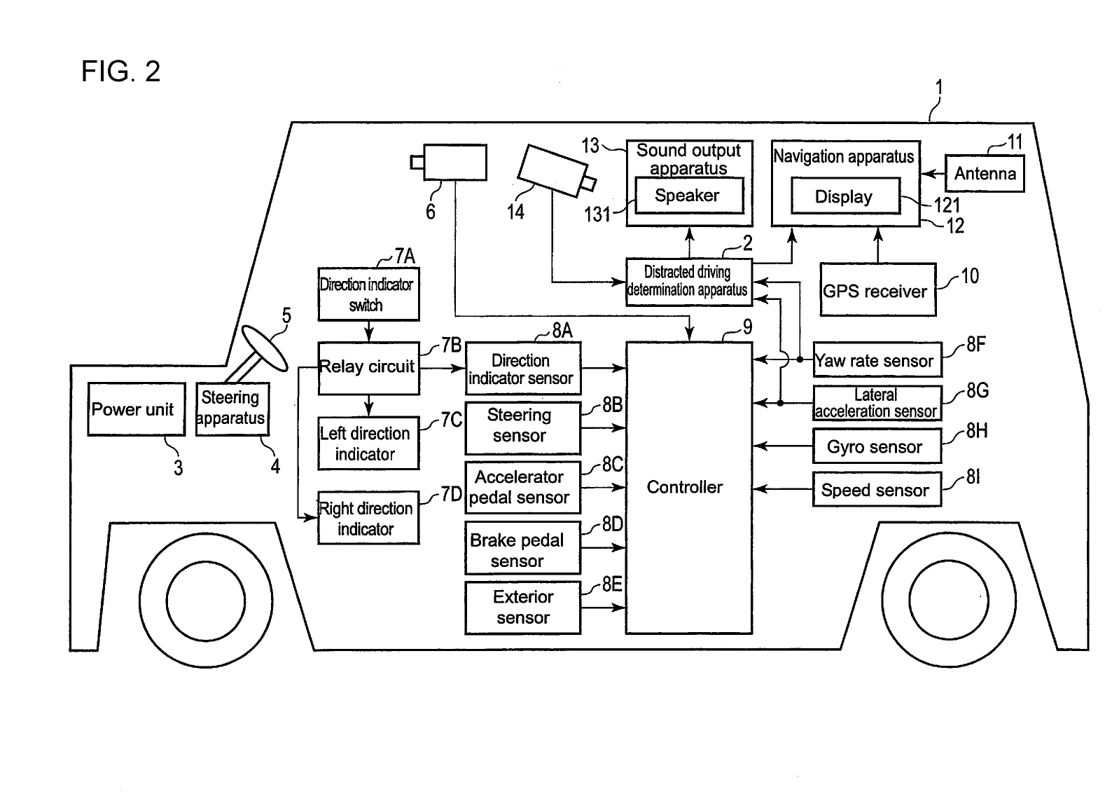

FIG. 2 is a schematic diagram of the vehicle 1 including the distracted driving determination apparatus 2. The vehicle 1 may be any of, for example, an automobile, a bus, a truck, and a train or may be any other vehicle drivable by a driver.

The vehicle 1 includes the distracted driving determination apparatus 2, a power unit 3, a steering apparatus 4, a steering wheel 5, an exterior view camera 6, a direction indicator switch 7A, a relay circuit 7B, a left direction indicator 7C, a right direction indicator 7D, a direction indicator sensor 8A, a steering sensor 8B, an accelerator pedal sensor 8C, a brake pedal sensor 8D, an exterior sensor 8E, a yaw rate sensor 8F, a lateral acceleration sensor 8G, a gyro sensor 8H, a speed sensor 8I, a controller 9, a global positioning system (GPS) receiver 10, an antenna apparatus 11, a navigation apparatus 12, a sound output apparatus 13, and a driver camera 14.

The distracted driving determination apparatus 2 determines whether the driver is engaging in distracted driving based on the gaze or face orientation of the driver and the distracted driving determination condition. The determination condition is defined by the multiple imaginary areas defined around the driver and a duration for which the gaze or face orientation of the driver associated with at least one of the multiple areas is allowed to be retained (hereafter, retention allowable duration). Examples of the determination conditions will be described later. Distracted driving may also be referred to as inattentive driving.

The components of the distracted driving determination apparatus 2 will be described later.

The power unit 3 includes a power source and a transmission. The power source includes an engine or a motor or both.

The steering apparatus 4 changes the traveling direction of the vehicle 1.

The steering wheel 5 is connected to the steering apparatus 4. The steering wheel 5 is operated by the driver to change the traveling direction of the vehicle 1.

The exterior view camera 6 captures an image of the exterior of the vehicle 1. For example, the exterior view camera 6 constantly captures images in front of the vehicle 1. The exterior view camera 6 outputs the captured images (hereafter, exterior image data) to the controller 9. The exterior view camera 6 is installed at a given position of the vehicle 1. Although FIG. 1 shows the single exterior view camera 6, the vehicle 1 may include multiple exterior view cameras 6 for capturing images in different directions.

The direction indicator switch 7A is operated by the driver to activate the left direction indicator 7C or the right direction indicator 7D when changing the traveling direction of the vehicle 1. When changing the traveling direction of the vehicle 1 leftward, the driver manually switches the direction indicator switch 7A from its initial position to a first position. When changing the traveling direction of the vehicle 1 rightward, the driver manually switches the direction indicator switch 7A from its initial position to a second position. The direction indicator switch 7A is manually switched by the driver from the first position or the second position back to the initial position. The direction indicator switch 7A may switch from the first position back to the initial position in cooperation with when the driver operating the steering wheel 5 counterclockwise operates the steering wheel 5 back to its initial position. Similarly, the direction indicator switch 7A may switch from the second position back to the initial position in cooperation with when the driver operating the steering wheel clockwise operates the steering wheel back to the initial position.

The relay circuit 7B supplies power to the left direction indicator 7C or the right direction indicator 7D in accordance with the position of the direction indicator switch 7A. The relay circuit 7B starts supplying power to the left direction indicator 7C in response to switching of the direction indicator switch 7A from the initial position to the first position. The relay circuit 7B continuously supplies power to the left direction indicator 7C while the direction indicator switch 7A is at the first position. The relay circuit 7B stops supplying power to the left direction indicator 7C in response to switching of the direction indicator switch 7A from the first position to the initial position. Similarly, the relay circuit 7B starts supplying power to the right direction indicator 7D in response to switching of the direction indicator switch 7A from the initial position to the second position. The relay circuit 7B continuously supplies power to the right direction indicator 7D while the direction indicator switch 7A is at the second position. The relay circuit 7B stops supplying power to the right direction indicator 7D in response to switching of the direction indicator switch 7A from the second position to the initial position.

The left direction indicator 7C is connected to the relay circuit 7B. The left direction indicator 7C includes, for example, a lightbulb or a light-emitting diode (LED). The left direction indicator 7C may be mounted on a left part of the vehicle 1. Although FIG. 1 shows the single left direction indicator 7C, the vehicle 1 includes multiple left direction indicators 7C at positions including a left front end and a left rear end of the vehicle 1. The left direction indicator 7C blinks when powered through the relay circuit 7B.

The right direction indicator 7D is connected to the relay circuit 7B. The right direction indicator 7D includes, for example, a lightbulb or an LED. The right direction indicator 7D may be mounted on a right part of the vehicle 1. Although FIG. 1 shows the single right direction indicator 7D, the vehicle 1 includes multiple right direction indicators 7D at multiple positions including a right front end and a right rear end of the vehicle 1. The right direction indicator 7D blinks when powered through the relay circuit 7B.

The direction indicator sensor 8A is included in the relay circuit 7B. The direction indicator sensor 8A detects an operation start and an operation end of the left direction indicator 7C based on the state of power supply to the left direction indicator 7C through the relay circuit 7B. The direction indicator sensor 8A detects an operation start and an operation end of the right direction indicator 7D based on the state of power supply to the right direction indicator 7D through the relay circuit 7B. The direction indicator sensor 8A outputs detection information indicating the operational state of each direction indicator to the controller 9. The direction indicator refers to either the left direction indicator 7C or the right direction indicator 7D. The detection information indicating the operational state of each direction indicator indicates an operational state selected from an operation start of the left direction indicator 7C, an operation end of the left direction indicator 7C, an operation start of the right direction indicator 7D, and an operation end of the right direction indicator 7D.

The steering sensor 8B detects a steering angle. The steering sensor 8B outputs detection information indicating the steering angle to the distracted driving determination apparatus 2 and the controller 9.

The accelerator pedal sensor 8C detects an operational quantity of an accelerator pedal. The accelerator pedal sensor 8C outputs detection information indicating the operational quantity of the accelerator pedal to the controller 9.

The brake pedal sensor 8D detects an operational quantity of a brake pedal. The brake pedal sensor 8D outputs detection information indicating the operational quantity of the brake pedal to the controller 9.

The exterior sensor 8E may be, for example, a millimeter wave sensor. The exterior sensor 8E detects the position of an object external to the vehicle 1. The exterior sensor 8E outputs detection information indicating the position of the object to the controller 9.

The yaw rate sensor 8F detects a rotational angle velocity about the vertical axis of the vehicle 1. The yaw rate sensor 8F outputs detection information indicating the rotational angle velocity to the controller 9.

The lateral acceleration sensor 8G detects an acceleration in a lateral direction (width direction) of the vehicle 1 (hereafter, lateral acceleration). The lateral acceleration sensor 8G outputs detection information indicating the lateral acceleration to the controller 9.

The gyro sensor 8H detects the behavior of the vehicle 1. The gyro sensor 8H outputs detection information indicating a quantity associated with the behavior of the vehicle 1 to the controller 9.

The speed sensor 8I detects the speed of the vehicle 1. The speed sensor 8I outputs detection information indicating the speed to the distracted driving determination apparatus 2 and the controller 9.

The controller 9 receives exterior image data from the exterior view camera 6 and detection information from the direction indicator sensor 8A, the steering sensor 8B, the accelerator pedal sensor 8C, the brake pedal sensor 8D, the exterior sensor 8E, the yaw rate sensor 8F, the lateral acceleration sensor 8G, the gyro sensor 8H, and the speed sensor 8I. The controller 9 uses detection information from at least one of these sensors to support driving of the vehicle 1.

The GPS receiver 10 receives GPS signals transmitted from multiple GPS satellites, and calculates the current location of the vehicle 1 based on the GPS signals. The GPS receiver 10 outputs information indicating the current location (hereafter, current location information) to the navigation apparatus 12.

The antenna apparatus 11 receives information including road traffic information, or specifically information from the Vehicle Information and Communication System (VICS, registered trademark), with at least one of frequency modulation (FM) multiplex broadcasting, a radio wave beacon, and a light beacon. The road traffic information includes, for example, traffic jam information and traffic control information. The antenna apparatus 11 transmits the road traffic information to the navigation apparatus 12.

The navigation apparatus 12 is an example of an image display device including a display 121 for displaying an image. The navigation apparatus 12 stores map data. The map data includes information about the features of roads.

The navigation apparatus 12 uses information about a destination input by, for example, the driver, map data, and current location information from the GPS receiver 10 to extract information about routes from the current location to the destination. The navigation apparatus 12 displays the route information on the display 121. The navigation apparatus 12 displays road traffic information from the antenna apparatus 11 on the display 121. The navigation apparatus 12 may display information other than the route information and the road traffic information on the display 121.

The sound output apparatus 13 includes a speaker 131. The sound output apparatus 13 outputs various items of information using sounds.

The driver camera 14 constantly captures images of a predefined range including the face of the driver. The driver camera 14 is installed in front of the driver, for example, on a dashboard. The driver camera 14 is an example of a sensor for monitoring the driver. The driver camera 14 captures images (hereafter, driver image data) and outputs the data to the distracted driving determination apparatus 2. The driver image data is an example of monitoring data used for detecting distracted driving of the driver.

### Distracted Driving Determination Apparatus

### Hardware Configuration

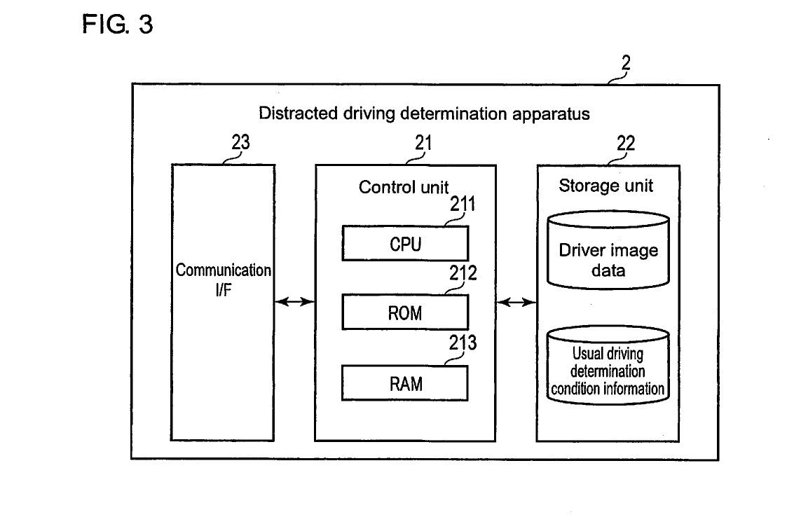

FIG. 3 is a block diagram of the distracted driving determination apparatus 2 showing its hardware configuration.

The distracted driving determination apparatus 2 includes a control unit 21, a storage unit 22, and a communication interface 23, which are electrically connected to one another. In FIG. 3, the communication interface is abbreviated as the communication I/F.

The control unit 21 will now be described.

The control unit 21 controls the operation of each unit in the distracted driving determination apparatus 2. The control unit 21 includes a central processing unit (CPU) 211, a read only memory (ROM) 212, and a random access memory (RAM) 213. The CPU 211 is an example of a processor. The CPU 211 expands, in the RAM 213, programs stored in the storage unit 22 for functioning the distracted driving determination apparatus 2. The CPU 211 then interprets and executes the programs expanded in the RAM 213. This allows the control unit 21 to implement the function of each unit in the software configuration described later.

The storage unit 22 will now be described.

The storage unit 22 is an auxiliary storage device. The storage unit 22 may be, but not limited to, a hard disk drive (HDD). The storage unit 22 stores programs executable by the control unit 21. The programs enable the distracted driving determination apparatus 2 to function as each unit in the software configuration described later. The programs may be stored in the storage unit 22, or may be downloaded to the distracted driving determination apparatus 2 through a network. The programs may be prestored in a non-transitory computer-readable medium, such as a compact disc read-only memory (CD-ROM) and distributed.

The storage unit 22 stores data used by the control unit 21 as described below.

The storage unit 22 stores driver image data received from the driver camera 14 to the control unit 21. For example, the control unit 21 receives the driver image data from the driver camera 14 at predetermined intervals and stores the data into the storage unit 22.

The storage unit 22 stores information (usual driving determination condition information) indicating a determination condition for usual driving (usual driving determination condition), which is one determination condition for detecting distracted driving.

Usual driving herein refers to driving when a change in the traveling direction of the vehicle 1 with respect to the straight traveling direction of the vehicle 1 satisfies a predefined criterion, which is associated with relaxing of the determination condition. The criterion includes a first criterion associated with left turning and a second criterion associated with right turning. The first criterion is associated with relaxing of the determination condition for the left of the vehicle 1. The first criterion is predefined. The first criterion includes a reference value for the absolute value of the quantity of change in the traveling direction associated with left turning with respect to the straight traveling direction of the vehicle 1. When the absolute value of the quantity of change in the traveling direction associated with left turning with respect to the straight traveling direction of the vehicle 1 is greater than the reference value, the change in the traveling direction associated with left turning fails to satisfy the first criterion. The second criterion is associated with relaxing of the determination condition for the right of the vehicle 1. The second criterion is predefined. The second criterion includes a reference value for the absolute value of the quantity of change in the traveling direction associated with right turning with respect to the straight traveling direction of the vehicle 1. When the absolute value of the quantity of change in the traveling direction associated with right turning with respect to the straight traveling direction of the vehicle 1 is greater than the reference value, the change in the traveling direction associated with right turning fails to satisfy the second criterion. The reference value included in the first criterion or the reference value included in the second criterion may be set to any value. The reference value included in the first criterion may be the same as or different from the reference value included in the second criterion. Although the reference value included in the first criterion and the reference value included in the second criterion may be zero, the reference value may desirably be a value other than zero. This is because the vehicle 1 may change the traveling direction depending on, for example, the road conditions although the driver does not intend to change the traveling direction of the vehicle 1.

Examples of the usual driving determination condition will be described later.

The communication interface 23 will now be described.

The communication interface 23 connects the direction indicator sensor 8A, the speed sensor 8I, the navigation apparatus 12, the sound output apparatus 13, and the driver camera 14 to the control unit 21. The communication interface 23 may include an interface for wired communication or an interface for wireless communication.

For the specific hardware configuration of the distracted driving determination apparatus 2, components may be eliminated, substituted, or added as appropriate. For example, the control unit 21 may include multiple processors.

### Usual Driving Determination Condition

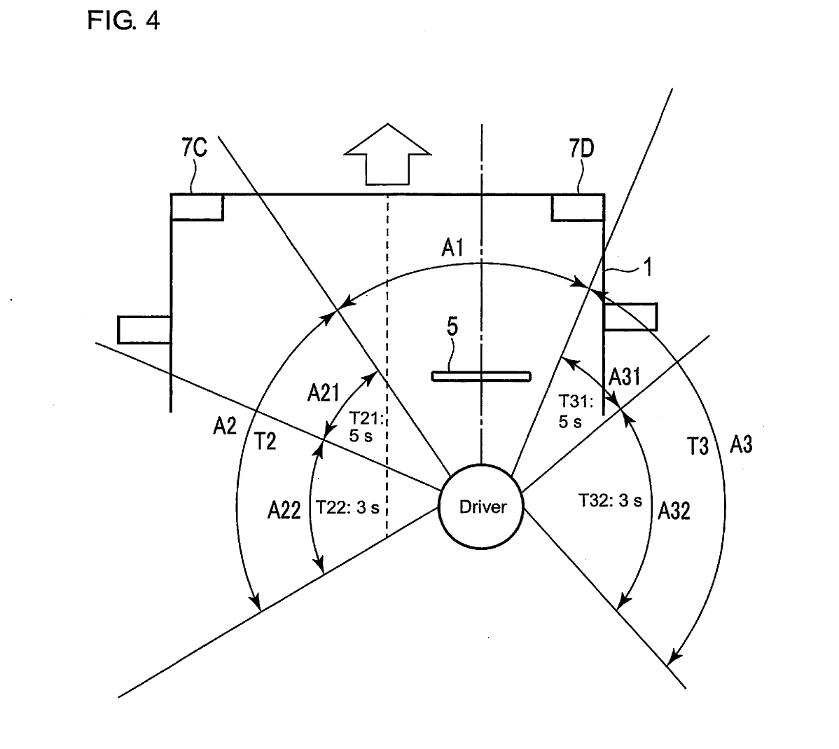

FIG. 4 is a schematic diagram describing a usual driving determination condition. FIG. 4 is a plan view of the vehicle 1 as viewed from above. The radial solid lines indicate the imaginary areas A1, A2, and A3. The broken line indicates the centerline in the width direction of the vehicle 1. The dot-and-dash line indicates the straight traveling direction of the vehicle 1.

The usual driving determination condition includes conditions for usual driving for the imaginary first area A1 horizontally ranging from the driver at the first angle, the imaginary second area A2 horizontally ranging from the driver at the second angle, and the imaginary third area A3 horizontally ranging from the driver at the third angle.

The first area A1 will now be described.

The first area A1 is an imaginary area horizontally ranging from the driver toward the front of the vehicle 1 at a first angle. The first area A1 is associated with driving with no distraction. More specifically, the first area A1 is not associated with a duration for which the gaze or face orientation of the driver is allowed to be retained. The distracted driving determination apparatus 2 thus determines that the driver is not engaging in distracted driving when his or her gaze or face orientation is retained within the first area A1 as described below.

The usual driving determination condition defines, for example, the first area A1 including the straight traveling direction of the vehicle 1. The usual driving determination condition defines the first angle as a predetermined angle. The predetermined angle may be set to any angle.

The second area A2 will now be described.

The second area A2 is an imaginary area adjacent to the first area A1 and horizontally ranging from the driver toward the left of the vehicle 1 at a second angle. The second area A2 is associated with a retention allowable duration T2. The retention allowable duration T2 is an example of the first duration for which the gaze or face orientation of the driver associated with at least a part of the second area is allowed to be retained. As described later, the distracted driving determination apparatus 2 thus determines that the driver is engaging in distracted driving when his or her gaze or face orientation is retained within the second area A2 for a duration longer than the retention allowable duration T2.

The usual driving determination condition defines the position of the second area A2 using the boundary position between the first and second areas A1 and A2 and the second angle. The usual driving determination condition defines the boundary position between the first and second areas A1 and A2 as a predetermined position. The predetermined position may be set to any position. The usual driving determination condition defines the second angle as a predetermined angle. The predetermined angle may be set to any angle.

The usual driving determination condition defines the second area A2 including a sub-area A21 and a sub-area A22, which are associated with the allowable durations having different lengths.

The sub-area A21 is an imaginary area adjacent to the first area A1 and horizontally ranging at a fourth angle.

The usual driving determination condition defines the position of the sub-area A21 using the boundary position between the first and second areas A1 and A2 and the fourth angle. The usual driving determination condition defines the fourth angle as a predetermined angle. The predetermined angle may be set to any angle.

The length of a retention allowable duration T21, which is associated with the sub-area A21, may be, but not limited to, five seconds. The retention allowable duration T21 is an example of the first duration.

The sub-area A22 is an imaginary area adjacent to the sub-area A21 and horizontally ranging at a fifth angle.

The usual driving determination condition defines the position of the sub-area A22 using the position of the sub-area A21 and the fifth angle. The usual driving determination condition defines the fifth angle as a predetermined angle. The predetermined angle may be set to any angle.

The length of a retention allowable duration T22, which is associated with the sub-area A22, may be, but not limited to, three seconds. The retention allowable duration T22 is an example of the first duration. The retention allowable duration T22 associated with the sub-area A22 is shorter than the retention allowable duration T21 associated with the sub-area A21. This is because the sub-area A22 is located rearward from the sub-area A21 in the vehicle 1 and thus is likely to affect the safety of driving when the gaze or face orientation of the driver is retained within the sub-area A22 for a long time whether or not for distracted driving or for checking for any obstacle before turning.

Although the second area A2 includes two sub-areas, the second area A2 may include no sub-area. In some embodiments, the second area A2 may include three or more sub-areas. In this case, the retention allowable duration associated with each sub-area is shorter as the sub-area is farther from the boundary between the first and second areas A1 and A2 counterclockwise as viewed from the driver.

The third area A3 will now be described.

The third area A3 is an imaginary area adjacent to the first area A1 and horizontally ranging from the driver toward the right of the vehicle 1 at a third angle. The third area A3 is associated with a retention allowable duration T3. The retention allowable duration T3 is an example of the second duration for which the gaze or face orientation of the driver associated with at least a part of the third area is allowed to be retained. As described later, the distracted driving determination apparatus 2 thus determines that the driver is engaging in distracted driving when his or her gaze or face orientation is retained within the third area A3 for a duration longer than the retention allowable duration T3.

The usual driving determination condition defines the position of the third area A3 using the boundary position between the first and third areas A1 and A3 and the third angle. The usual driving determination condition defines the boundary position between the first and third areas A1 and A3 as a predetermined position. The predetermined position may be set to any position. The usual driving determination condition defines the third angle as a predetermined angle. The predetermined angle may be set to any angle.

The usual driving determination condition defines the third area A3 including a sub-area A31 and a sub-area A32, which are associated with retention allowable durations having different lengths.

The sub-area A31 is an imaginary area adjacent to the first area A1 and horizontally ranging at a sixth angle.

The usual driving determination condition defines the position of the sub-area A31 using the boundary position between the first and third areas A1 and A3 and the sixth angle. The usual driving determination condition defines the sixth angle as a predetermined angle. The predetermined angle may be set to any angle.

The length of a retention allowable duration T31, which is associated with the sub-area A31, may be, but not limited to, five seconds. The retention allowable duration T31 is an example of the second duration.

The sub-area A32 is an imaginary area adjacent to the sub-area A31 and horizontally ranging at a seventh angle.

The usual driving determination condition defines the position of the sub-area A32 using the position of the sub-area A31 and the seventh angle. The usual driving determination condition defines the seventh angle as a predetermined angle. The predetermined angle may be set to any angle.

The length of a retention allowable duration T32, which is associated with the sub-area A32, may be, but not limited to, three seconds. The retention allowable duration T32 is an example of the second duration. The retention allowable duration T32 associated with the sub-area A32 is shorter than the retention allowable duration T31 associated with the sub-area A31. This is because the sub-area A32 is located rearward from the sub-area A31 in the vehicle 1 and thus is likely to affect the safety of driving when the gaze or face orientation of the driver is retained within the sub-area A32 for a long time whether or not for distracted driving or for checking for any obstacle before turning.

Although the third area A3 includes two sub-areas, the third area A3 may include no sub-area. In some embodiments, the third area A3 may include three or more sub-areas. In this case, the allowable duration associated with each sub-area is shorter as the sub-area is farther from the boundary between the first and third areas A1 and A3 clockwise as viewed from the driver.

The deviation (angle) of the boundary between the first and second areas A1 and A2 from the straight traveling direction of the vehicle 1 may or may not have the same absolute value as the deviation (angle) of the boundary between the first and third areas A1 and A3 from the straight traveling direction of the vehicle 1. The deviation (angle) of the boundary between the sub-areas A21 and A22 from the straight traveling direction of the vehicle 1 may or may not have the same absolute value as the deviation (angle) of the boundary between the sub-areas A31 and A32 from the straight traveling direction of the vehicle 1.

### Software Configuration

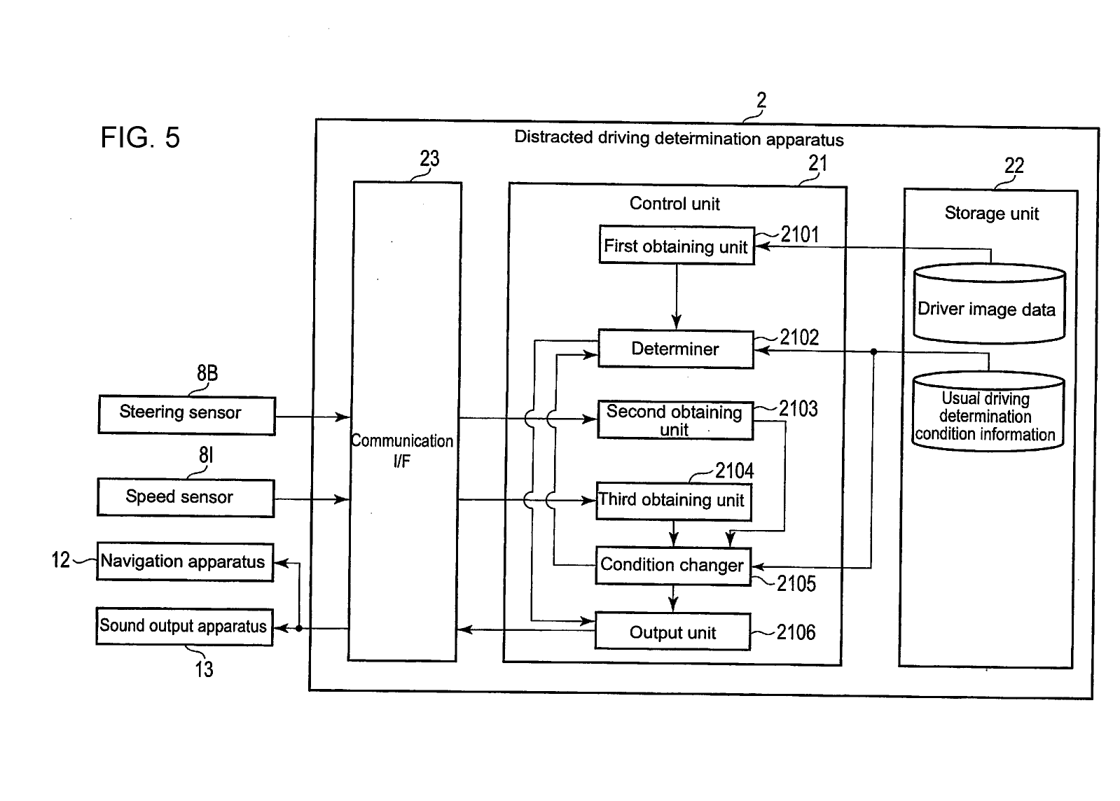

FIG. 5 is a block diagram of the distracted driving determination apparatus 2 showing its software configuration.

The control unit 21 includes a first obtaining unit 2101, a determiner 2102, a second obtaining unit 2103, a third obtaining unit 2104, a condition changer 2105, and an output unit 2106.

The first obtaining unit 2101 will now be described.

The first obtaining unit 2101 obtains first detection information indicating the gaze or face orientation of the driver as described below.

The first obtaining unit 2101 first obtains the driver image data for the driver of the vehicle 1. The first obtaining unit 2101 may constantly obtain the driver image data from the storage unit 22. In some embodiments, the first obtaining unit 2101 may constantly obtain the driver image data from the driver camera 14. The first obtaining unit 2101 then determines, for example, the state of the eyes of the driver captured in the driver image data to detect the gaze or face orientation of the driver. Thus, the first obtaining unit 2101 obtains detection information indicating the gaze or face orientation of the driver (hereafter, first detection information).

The first obtaining unit 2101 outputs the first detection information to the determiner 2102.

The determiner 2102 will now be described.

As illustrated below, the determiner 2102 determines whether the driver is engaging in distracted driving based on the first detection information indicating the gaze or face orientation of the driver and the determination condition.

The determiner 2102 first receives the first detection information from the first obtaining unit 2101. The determiner 2102 then obtains the determination condition. When the distracted driving determination apparatus 2 is activated, the determiner 2102 obtains the usual driving determination condition information from the storage unit 22 and uses the usual driving determination condition. When the determination condition is changed by the condition changer 2105 (described later), the determiner 2102 receives information specifying the changed determination condition from the condition changer 2105. The determiner 2102 may use the resultant determination condition.

The determiner 2102 then determines that the driver is not engaging in distracted driving when the gaze or face orientation of the driver is retained within the first area A1. The determiner 2102 determines that the driver is engaging in distracted driving when his or her gaze or face orientation is retained within the second area A2 for a duration longer than the retention allowable duration T2. In other words, the determiner 2102 determines that the driver is not engaging in distracted driving when the gaze or face orientation is retained within the second area A2 within the retention allowable duration T2. The determiner 2102 determines that the driver is engaging in distracted driving when his or her gaze or face orientation is retained within the third area A3 for a duration longer than the retention allowable duration T3. In other words, the determiner 2102 determines that the driver is not engaging in distracted driving when the gaze or face orientation is retained within the third area A3 within the retention allowable duration T3.

In response to detected distracted driving, the determiner 2102 outputs determination information indicating detected distracted driving to the output unit 2106.

The second obtaining unit 2103 will now be described.

The second obtaining unit 2103 obtains detection information indicating a change in the traveling direction of the vehicle 1 with respect to the straight traveling direction (hereafter, second detection information) as described below.

The second obtaining unit 2103 first obtains detection information indicating the steering angle from the steering sensor 8B.

Based on the detection information indicating the steering angle, the second obtaining unit 2103 detects a change in the traveling direction with respect to the straight traveling direction of the vehicle 1 corresponding to the steering angle. Thus, the second obtaining unit 2103 obtains the second detection information indicating the change in the traveling direction. The second detection information includes information indicating, as the quantity of change in the traveling direction with respect to the straight traveling direction of the vehicle 1 corresponding to the steering angle, one of zero, the absolute value of the quantity of change in the traveling direction associated with right turning with respect to the straight traveling direction of the vehicle 1, or the absolute value of the quantity of change in the traveling direction associated with left turning with respect to the straight traveling direction of the vehicle 1.

The second obtaining unit 2103 outputs the second detection information to the condition changer 2105.

The third obtaining unit 2104 will now be described.

The third obtaining unit 2104 obtains detection information indicating the traveling state of the vehicle 1 (hereafter, third detection information) as described below.

The third obtaining unit 2104 first obtains detection information indicating the speed obtained from the speed sensor 8I. The third obtaining unit 2104 then determines whether the vehicle 1 is traveling or stopped based on the detection information indicating the speed, and thus obtains third detection information. The third detection information indicates whether the vehicle 1 is traveling or stopped. The vehicle 1 traveling refers to the speed greater than or equal to a predetermined threshold being detected, whereas the vehicle 1 being stopped refers to the speed less than the threshold being detected. More specifically, the vehicle 1 being stopped may include the vehicle 1 being substantially stopped, or for example, moving on inertia, in addition to the vehicle 1 at the speed of zero.

The third obtaining unit 2104 outputs the third detection information to the condition changer 2105.

The condition changer 2105 will now be described.

As described below, the condition changer 2105 changes the determination condition.

The condition changer 2105 first receives the usual driving determination condition from the storage unit 22. The condition changer 2105 then receives the second detection information from the second obtaining unit 2103. Based on the second detection information, the condition changer 2105 detects the change in the traveling direction of the vehicle 1.

The condition changer 2105 then compares the change in the traveling direction of the vehicle 1 with a reference to detect the duration for which the vehicle 1 is determined to be traveling rightward or leftward. The above criterion is for determining whether the vehicle 1 is traveling straight or traveling rightward or leftward. The criterion is defined using, for example, a range of steering angles. The condition changer 2105 compares the quantity of change in the traveling direction associated with left turning with a reference value to detect the duration for which the vehicle 1 is turning left. The condition changer 2105 compares the quantity of change in the traveling direction associated with right turning with a reference value included in the second criterion to detect the duration for which the vehicle 1 is turning right.

The vehicle traveling straight described above includes the vehicle traveling along a curved road with the steering angle varying below a predetermined threshold, in addition to the vehicle traveling along a straight road. The vehicle traveling leftward is defined as the vehicle traveling in a direction in which the quantity of change in the steering angle exceeds the above threshold when the vehicle is turning left, changing the lane to the left, or pulling over to the side of a road. The vehicle traveling rightward is defined as the vehicle traveling in a direction in which the quantity of change in the steering angle exceeds the above threshold when the vehicle is turning right or changing the lane to the right.

The condition changer 2105 changes the determination condition to use the changed determination condition in the duration for which the change in the traveling direction of the vehicle 1 is being detected based on the second detection information. The determination condition is changed to lower the likelihood that distracted driving is detected.

The condition changer 2105 changes the determination condition for detecting distracted driving for the left of the vehicle 1 to use the changed determination condition in the duration for which the left turning of the vehicle 1 is being detected based on the second detection information as described below.

In response to detection of a change in the traveling direction associated with left turning, the condition changer 2105 performs a first change process at least by shifting the boundary between the first and second areas A1 and A2 counterclockwise as viewed from the driver from the boundary position when the vehicle 1 is traveling straight, or by extending the first duration in the second area A2. The determination condition resulting from the first change process for the usual driving determination condition is referred to as the left determination condition. The condition changer 2105 determines to use the left determination condition. In response to detection of the end of the left turning of the vehicle 1, the condition changer 2105 changes the determination condition from the left determination condition back to the usual driving determination condition. The condition changer 2105 determines to use the usual driving determination condition.

The condition changer 2105 may perform the first change process to change the determination condition for detecting distracted driving for the left of the vehicle 1 in accordance with the quantity of change in the traveling direction associated with left turning of the vehicle 1 to further lower the likelihood that distracted driving is detected. The condition changer 2105 increases, for example, the shift of the boundary position between the first and second areas A1 and A2 in accordance with the quantity of change in the traveling direction associated with left turning.

The condition changer 2105 further changes the determination condition for detecting distracted driving for the right of the vehicle 1 to use the changed determination condition in the duration for which a change in the traveling direction associated with right turning of the vehicle 1 is being detected based on the second detection information as described below.

In response to detection of a change in the traveling direction associated with right turning, the condition changer 2105 performs a second change process at least by shifting the boundary between the first and third areas A1 and A3 clockwise as viewed from the driver from the position when the change in the traveling direction of the vehicle 1 satisfies the criterion, or by extending the second duration in the third area A3. The determination condition resulting from the second change process for the usual driving determination condition is referred to as the right determination condition. The condition changer 2105 determines to use the right determination condition. In response to detection of the end of the right turning of the vehicle 1, the condition changer 2105 changes the determination condition from the right determination condition back to the usual driving determination condition. The condition changer 2105 determines to use the usual driving determination condition.

The condition changer 2105 may perform the second change process to change the determination condition for detecting distracted driving for the right of the vehicle 1 in accordance with the quantity of change in the traveling direction associated with right turning to further lower the likelihood that distracted driving is detected. The condition changer 2105 increases, for example, the shift of the boundary position between the first and third areas A1 and A3 in accordance with the quantity of change in the traveling direction associated with right turning.

The condition changer 2105 outputs information specifying the determination condition to the determiner 2102 upon every change of the determination condition. The information specifying the determination condition may be information indicating the usual driving determination condition, the left determination condition, or the right determination condition. When the condition changer 2105 changes the determination condition in accordance with the quantity of change in the traveling direction associated with left turning to further lower the likelihood that distracted driving is detected, the condition changer 2105 outputs information indicating a left determination condition corresponding to the quantity of change in the traveling direction associated with left turning. Similarly, when the condition changer 2105 changes the determination condition in accordance with the quantity of change in the traveling direction associated with right turning to further lower the likelihood that distracted driving is detected, the condition changer 2105 outputs information indicating a right determination condition corresponding to the quantity of change in the traveling direction associated with right turning.

The condition changer 2105 may determine whether to perform the first change process and the second change process as described below based on the third detection information received from the third obtaining unit 2104.

The condition changer 2105 first obtains the third detection information indicating whether the vehicle 1 is traveling or stopped from the third obtaining unit 2104.

The condition changer 2105 then determines whether the vehicle 1 is traveling based on the third detection information.

When determining that the vehicle 1 is traveling, the condition changer 2105 then performs the first change process in response to detection of a change in the traveling direction associated with left turning. Similarly, when determining that the vehicle 1 is traveling, the condition changer 2105 performs the second change process in response to detection of a change in the traveling direction associated with right turning. When determining that the vehicle 1 is stopped, the condition changer 2105 disables the first change process and the second change process. In other words, when the vehicle 1 is stopped, the condition changer 2105 does not perform the first change process irrespective of whether a change in the traveling direction associated with left turning is detected. Similarly, when the vehicle 1 is stopped, the condition changer 2105 does not perform the second change process irrespective of whether a change in the traveling direction associated with right turning is detected.

The output unit 2106 will now be described.

As described below, the output unit 2106 outputs an instruction signal to support the driver based on the determination information indicating that the driver is engaging in distracted driving.

The output unit 2106 first obtains the determination information indicating that the driver is engaging in distracted driving from the determiner 2102. The output unit 2106 then outputs an instruction signal to a support apparatus based on the determination information indicating that the driver is engaging in distracted driving.

The support apparatus may include the navigation apparatus 12 and the sound output apparatus 13. The support apparatus may include, for example, an apparatus that externally stimulates the driver by providing vibrations for example, in addition to the navigation apparatus 12 and the sound output apparatus 13. The support apparatus that has received the instruction signal from the output unit 2106 starts supporting the driver. Supporting the driver includes providing an output that acts on the driver, including an alert, a caution, and notification, and various other forms of support to improve the driver's focus on driving.

### Left Determination Condition

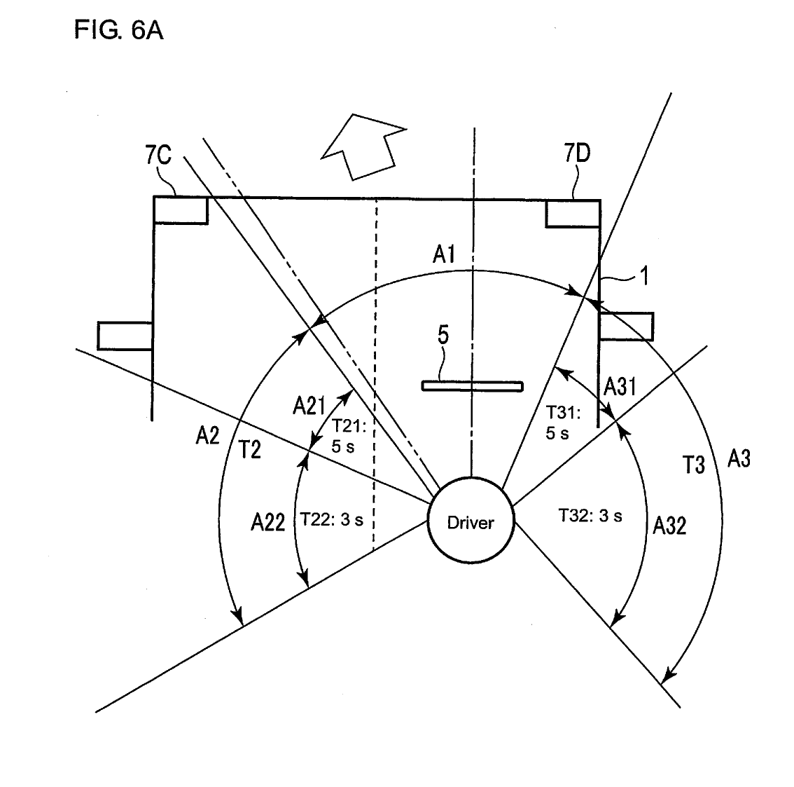

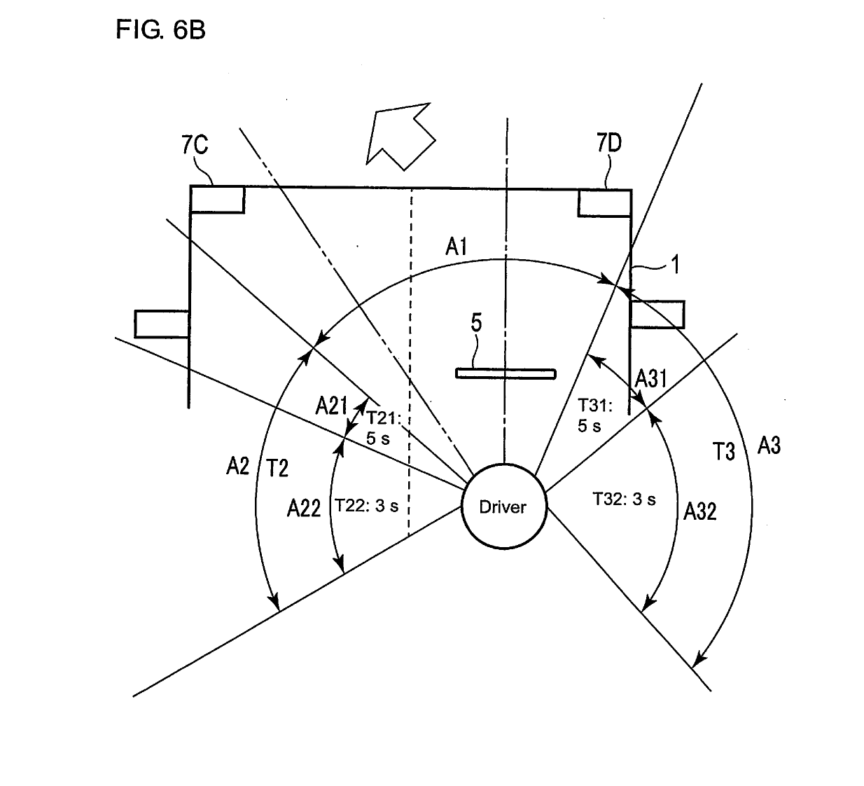

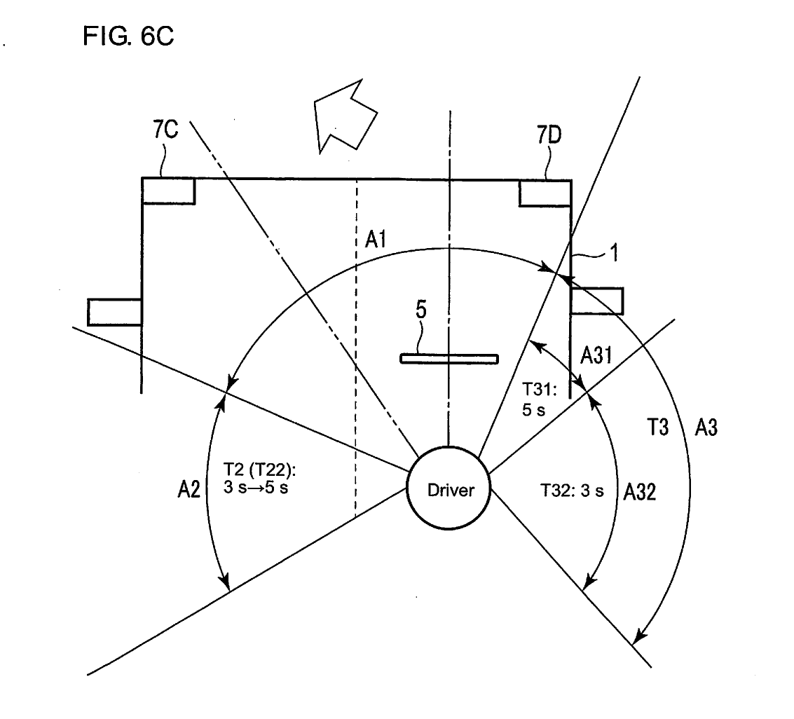

FIGS. 6A, 6B, and 6C are schematic diagrams describing the left determination condition resulting from the first change process for the usual driving determination condition. In the examples shown in FIGS. 6A, 6B, and 6C, the boundary between the first and second areas A1 and A2 is shifted in accordance with the quantity of change in the traveling direction associated with left turning and the first duration is extended for the usual driving determination condition.

FIGS. 6A, 6B, and 6C show the vehicle 1 as viewed from above. The radial solid lines indicate the imaginary areas A1, A2, and A3. The broken line indicates the centerline in the width direction of the vehicle 1. The dot-and-dash line indicates the straight traveling direction of the vehicle 1. The two-dot chain line indicates the boundary position between the first and second areas A1 and A2 under the usual driving determination condition, or in other words, when the vehicle 1 is traveling straight.

FIGS. 6A, 6B, and 6C relate to one another in the manner below. The quantity of change in the traveling direction associated with left turning of the vehicle 1 shown in FIG. 6B is greater than the quantity of change in the traveling direction associated with left turning of the vehicle 1 shown in FIG. 6A. The quantity of change in the traveling direction associated with left turning of the vehicle 1 shown in FIG. 6C is greater than the quantity of change in the traveling direction associated with left turning of the vehicle 1 shown in FIG. 6B.

The left determination condition will be described below with reference to FIGS. 6A, 6B, and 6C. The left determination condition below is a mere example, and may be any determination condition for the left of the vehicle 1 changed from the usual driving determination condition to further lower the likelihood that distracted driving of the driver is detected.

The first area A1 and the second area A2 will be described first.

The first area A1 and the second area A2 together are at the same positions and in the same ranges as under the usual driving determination condition. The boundary position between the first and second areas A1 and A2 differs from the position under the usual driving determination condition. The boundary between the first and second areas A1 and A2 is at a position rotated counterclockwise as viewed from the driver from the boundary position under the usual driving determination condition. The shift of the boundary position between the first and second areas A1 and A2 increases in accordance with the quantity of change in the traveling direction associated with left turning. When the quantity of change in the traveling direction associated with left turning reaches its maximum, the boundary position between the first and second areas A1 and A2 is shifted to the boundary position between the sub-areas A21 and A22 under the normal driving determination condition as shown in FIG. 6C.

The first angle of the first area A1 is set larger than the angle under the usual driving determination condition as the quantity of change in the traveling direction associated with left turning increases. Thus, the first area A1 under the left determination condition is enlarged more than the first area A1 under the usual driving determination condition as the quantity of change in the traveling direction associated with left turning increases.

The end of the second area A2, which is opposite to the boundary between the first and second areas A1 and A2, is at the same position as under the usual driving determination condition. When the boundary position between the first and second areas A1 and A2 is shifted, the second angle of the second area A2 is set smaller than the angle under the usual driving determination condition as the quantity of change in the traveling direction associated with left turning increases. The fifth angle of the sub-area A22 is the same as under the usual driving determination condition. The fourth angle of the sub-area A21 is thus set smaller as the quantity of change in the traveling direction associated with left turning increases. When the quantity of change in the traveling direction associated with left turning reaches its maximum, the fourth angle of the sub-area A21 becomes zero, and the boundary position between the first and second areas A1 and A2 is shifted to the boundary position between the sub-areas A21 and A22 under the normal driving determination condition as shown in FIG. 6C. Thus, the second area A2 under the left determination condition is reduced from the second area A2 under the usual driving determination condition as the quantity of change in the traveling direction associated with left turning increases.

The length of the first duration will now be described.

The retention allowable duration T2 (e.g., 5 seconds) associated with the second area A2 under the left determination condition is longer than the retention allowable duration T22 (3 seconds) associated with the sub-area A22 under the usual driving determination condition as shown in FIG. 6C.

The retention allowable duration T21 associated with the sub-area A21 under the left determination condition may be set gradually longer than the duration under the normal driving determination condition as the quantity of change in the traveling direction associated with left turning increases. Similarly, the retention allowable duration T22 associated with the sub-area A22 under the left determination condition may be set gradually longer than the duration under the normal driving determination condition as the quantity of change in the traveling direction associated with left turning increases.

When the process for shifting the boundary between the first and second areas A1 and A2 is eliminated, the retention allowable duration T21 associated with the sub-area A21 under the left determination condition is longer than under the usual driving determination condition. Similarly, the retention allowable duration T22 associated with the sub-area A22 under the left determination condition is longer than under the usual driving determination condition. Under the left determination condition, the retention allowable duration T21 associated with the sub-area A21 may or may not be the same as the retention allowable duration T22 associated with the sub-area A22. The retention allowable duration T21 associated with the sub-area A21 under the left determination condition may be set gradually longer than the duration under the normal driving determination condition as the quantity of change in the traveling direction associated with left turning increases. The retention allowable duration T22 associated with the sub-area A22 under the left determination condition may be set gradually longer than the duration under the normal driving determination condition as the quantity of change in the traveling direction associated with left turning increases.

The process for extending the first duration may be eliminated when the process for shifting the boundary between the first and second areas A1 and A2 is performed.

The third area A3 will now be described.

The boundary between the first and third areas A1 and A3 is at the same position as under the usual driving determination condition. The end of the third area A3, which is located opposite to the boundary between the first and third areas A1 and A3, is at the same position as under the usual driving determination condition. The third angle of the third area A3 is the same as under the usual driving determination condition. Thus, the position and the range of the third area A3 are the same as those under the usual driving determination condition. The sixth angle of the sub-area A31 is the same as under the usual driving determination condition. Thus, the position and the range of the sub-area A31 are the same as those under the usual driving determination condition. The length of the retention allowable duration T31 associated with the sub-area A31 is the same as the length under the usual driving determination condition. The seventh angle of the sub-area A32 is the same as under the usual driving determination condition. Thus, the position and the range of the sub-area A32 are the same as those under the usual driving determination condition. The length of the retention allowable duration T32 associated with the sub-area A32 is the same as the length under the usual driving determination condition.

Thus, the positions and the ranges of the third area A3, the sub-area A31, and the sub-area A32, and the retention allowable duration T31 associated with the sub-area A31 and the retention allowable duration T32 associated with the sub-area A32 are the same for the left determination condition and the usual driving determination condition. This is because the driver is unlikely to look to the right of the vehicle 1 during changing of the traveling direction to the left with respect to the straight direction, and thus the distracted driving determination condition for the right of the vehicle 1 may not be changed to a value to lower the likelihood that distracted driving of the driver is detected.

The left determination condition may be set as described below.

The boundary position between the first and second areas A1 and A2 may differ between the vehicles 1 with the right driver's seat and the left driver's seat. The first duration may differ between the vehicles 1 with the right driver's seat and the left driver's seat. When the quantity of change in the traveling direction associated with left turning reaches its maximum, the boundary position between the first and second areas A1 and A2 may differ from the boundary position between the sub-areas A21 and A22 under the normal driving determination condition. The second angle of the second area A2 may be greater than the fifth angle of the sub-area A22 when the quantity of change in the traveling direction associated with left turning reaches its maximum. The end of the second area A2, which is located opposite to the boundary between the first and second areas A1 and A2, may be shifted counterclockwise as viewed from the driver from the position under the usual driving determination condition when the boundary position between the first and second areas A1 and A2 is shifted. The boundary position between the first and third areas A1 and A3 may differ from the position under the usual driving determination condition. The third angle of the third area A3 may differ from the angle under the usual driving determination condition. The sixth angle of the sub-area A31 and the seventh angle of the sub-area A32 may differ from those under the usual driving condition. The length of the retention allowable duration T31 associated with the sub-area A31 may differ from the length under the usual driving determination condition. The length of the retention allowable duration T32 associated with the sub-area A32 may differ from the length under the usual driving determination condition. The retention allowable duration T31 associated with the sub-area A31 may be the same as the retention allowable duration T32 associated with the sub-area A32.

### Right Determination Condition

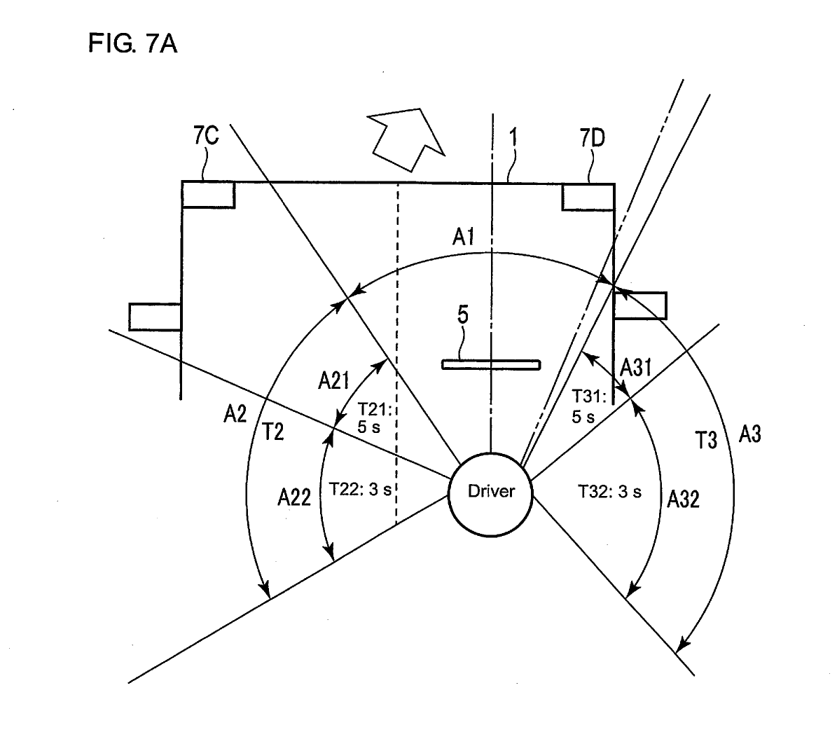

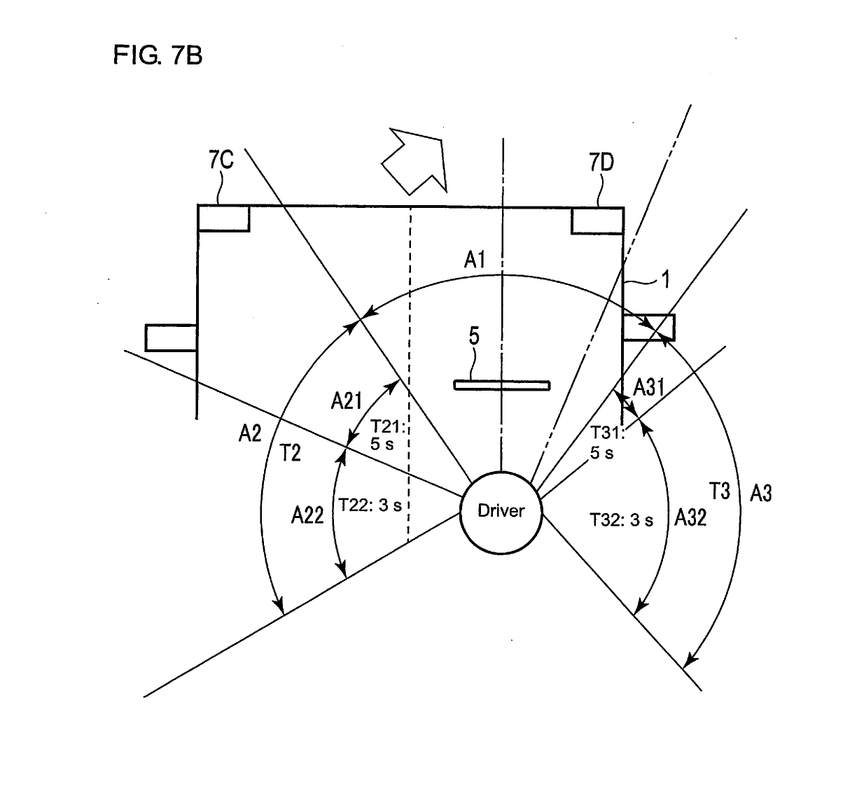

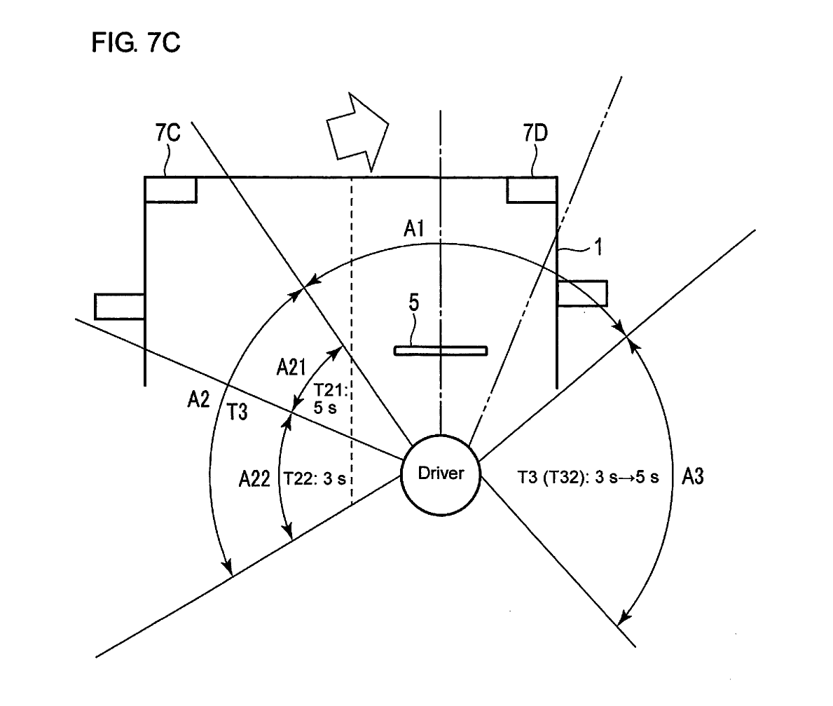

FIGS. 7A, 7B, and 7C are schematic diagrams describing the right determination condition resulting from the second change process for the usual driving determination condition. In the examples shown in FIGS. 7A, 7B, and 7C, the boundary between the first and third areas A1 and A3 is shifted in accordance with the quantity of change in the traveling direction associated with right turning and the second duration is extended for the usual driving determination condition. FIGS. 7A, 7B, and 7C show the vehicle 1 as viewed from above. The radial solid lines indicate the imaginary areas A1, A2, and A3. The broken line indicates the centerline in the width direction of the vehicle 1. The dot-and-dash line indicates the straight traveling direction of the vehicle 1. The two-dot chain line indicates the boundary position between the first and third areas A1 and A3 under the usual driving determination condition.

FIGS. 7A, 7B, and 7C relate to one another in the manner below. The quantity of change in the traveling direction associated with right turning of the vehicle 1 shown in FIG. 7B is greater than the quantity of change in the traveling direction associated with right turning of the vehicle 1 shown in FIG. 7A. The quantity of change in the traveling direction associated with right turning of the vehicle 1 shown in FIG. 7C is greater than the quantity of change in the traveling direction associated with right turning of the vehicle 1 shown in FIG. 7B.

The right determination condition will be described below with reference to FIGS. 7A, 7B, and 7C. The right determination condition below is a mere example, and may be any determination condition for the right of the vehicle 1 changed from the usual driving determination condition to further lower the likelihood that distracted driving of the driver is detected.

The first area A1 and the third area A3 will be described first.

The first area A1 and the third area A3 together are at the same positions and in the same ranges as under the usual driving determination condition. The boundary between the first and third areas A1 and A3 is at the same position as under the usual driving determination condition. The boundary between the first and third areas A1 and A3 is at a position rotated clockwise as viewed from the driver from the boundary position under the usual driving determination condition. The shift of the boundary position between the first and third areas A1 and A3 increases in accordance with the quantity of change in the traveling direction associated with right turning. When the quantity of change in the traveling direction associated with right turning reaches its maximum, the boundary position between the first and third areas A1 and A3 is shifted to the boundary position between the sub-areas A31 and A32 under the normal driving determination condition as shown in FIG. 7C.

The first angle of the first area A1 is set larger than the angle under the usual driving determination condition as the quantity of change in the traveling direction associated with right turning increases. Thus, the first area A1 under the right determination condition is enlarged more than the first area A1 under the usual driving determination condition as the quantity of change in the traveling direction associated with right turning increases.

The end of the third area A3, which is located opposite to the boundary between the first and third areas A1 and A3, is at the same position as under the usual driving determination condition. When the boundary position between the first and third areas A1 and A3 is shifted, the third angle of the third area A3 is set smaller than the angle under the usual driving determination condition as the quantity of change in the traveling direction associated with right turning increases. The seventh angle of the sub-area A32 is the same as under the usual driving determination condition. The sixth angle of the sub-area A31 is thus set smaller as the quantity of change in the traveling direction associated with right turning increases. When the quantity of change in the traveling direction associated with right turning reaches its maximum, the sixth angle of the sub-area A31 becomes zero, and the boundary position between the first and third areas A1 and A3 is shifted to the boundary position between the sub-areas A31 and A32 under the normal driving determination condition as shown in FIG. 7C. Thus, the third area A3 under the right determination condition is reduced from the third area A3 under the usual driving determination condition as the quantity of change in the traveling direction associated with right turning increases.

The length of the second duration will now be described.

The retention allowable duration T3 (e.g., 5 seconds) associated with the third area A3 under the right determination condition is longer than the retention allowable duration T32 (3 seconds) associated with the sub-area A32 under the usual driving determination condition as shown in FIG. 7C.

The retention allowable duration T31 associated with the sub-area A31 under the right determination condition may be set gradually longer than the duration under the normal driving determination condition as the quantity of change in the traveling direction associated with right turning increases. Similarly, the retention allowable duration T32 associated with the sub-area A32 under the right determination condition may be set gradually longer than the duration under the normal driving determination condition as the quantity of change in the traveling direction associated with right turning increases.

When the process for shifting the boundary between the first and third areas A1 and A3 is eliminated, the retention allowable duration T31 associated with the sub-area A31 under the right determination condition is longer than the duration under the usual driving determination condition. Similarly, the retention allowable duration T32 associated with the sub-area A32 under the right determination condition is longer than the duration under the usual driving determination condition. Under the right determination condition, the retention allowable duration T31 associated with the sub-area A31 may or may not be the same as the retention allowable duration T32 associated with the sub-area A32. The retention allowable duration T31 associated with the sub-area. A31 under the right determination condition may be set gradually longer than the duration under the normal driving determination condition as the quantity of change in the traveling direction associated with right turning increases. The retention allowable duration T32 associated with the sub-area A32 under the right determination condition may be set gradually longer than the duration under the normal driving determination condition as the quantity of change in the traveling direction associated with right turning increases.

The process for extending the second duration may be eliminated when the process for shifting the boundary between the first and third areas A1 and A3 is performed.

The second area A2 will now be described.

The boundary position between the first and second areas A1 and A2 is at the same position as under the usual driving determination condition. The end of the second area A2, which is located opposite to the boundary between the first and second areas A1 and A2, is at the same position as under the usual driving determination condition. The second angle of the second area A2 is the same as under the usual driving determination condition. Thus, the position and the range of the second area A2 are the same as those under the usual driving determination condition.

The fourth angle of the sub-area A21 is the same as under the usual driving determination condition. Thus, the position and the range of the sub-area A21 are the same as those under the usual driving determination condition. The length of the retention allowable duration T21 associated with the sub-area A21 is the same as the length under the usual driving determination condition. The fifth angle of the sub-area A22 is the same as under the usual driving determination condition. Thus, the position and the range of the sub-area A22 are the same as those under the usual driving determination condition. The length of the retention allowable duration T22 associated with the sub-area A22 is the same as the length under the usual driving determination condition.

Thus, the positions and the ranges of the second area A2, the sub-area A21, and the sub-area A22, and the retention allowable duration T21 associated with the sub-area A21 and the retention allowable duration T22 associated with the sub-area A22 are the same for the right determination condition and the usual driving determination condition. This is because the driver is unlikely to look to the left of the vehicle 1 during changing of the traveling direction to the right with respect to the straight direction, and thus the distracted driving determination condition for the left of the vehicle 1 may not be relaxed.

The right determination condition may be set as described below.

The boundary position between the first and third areas A1 and A3 may differ between the vehicles 1 with the right driver's seat and the left driver's seat. The second duration may differ between the vehicles 1 with the right driver's seat and the left driver's seat. When the quantity of change in the traveling direction associated with right turning reaches its maximum, the boundary position between the first and third areas A1 and A3 may differ from the boundary position between the sub-areas A31 and A32 under the normal driving determination condition. The third angle of the third area A3 may be greater than the seventh angle of the sub-area A32 when the quantity of change in the traveling direction associated with right turning reaches its maximum. The end of the third area A3, which is located opposite to the boundary between the first and third areas A1 and A3, may be shifted clockwise as viewed from the driver from the position under the usual driving determination condition when the boundary position between the first and third areas A1 and A3 is shifted. The boundary position between the first and second areas A1 and A2 may differ from the position under the usual driving determination condition. The second angle of the second area A2 may differ from the angle under the usual driving determination condition. The fourth angle of the sub-area A21 and the fifth angle of the sub-area A22 may differ from those under the usual driving determination condition. The length of the retention allowable duration T21 associated with the sub-area A21 may differ from the length under the usual driving determination condition. The length of the retention allowable duration T22 associated with the sub-area A22 may differ from the length under the usual driving determination condition. The retention allowable duration T21 associated with the sub-area A21 may be the same as the retention allowable duration T22 associated with the sub-area A22.

### 3. Operation Examples

### Distracted Driving Determination Apparatus

### Operation for Determining Distracted Driving

The operation for determining distracted driving performed by the distracted driving determination apparatus 2 will now be described.

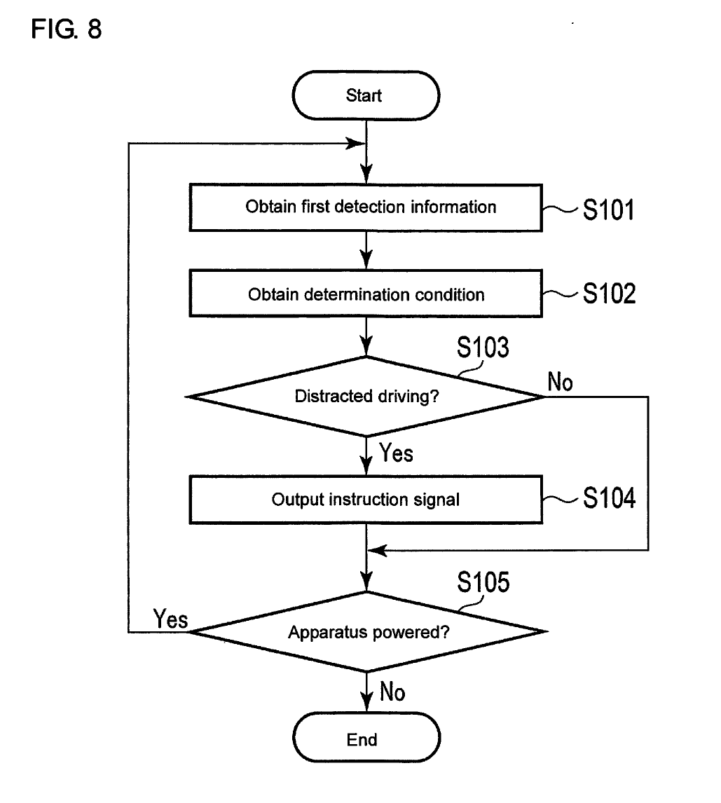

FIG. 8 is a flowchart showing distracted driving determination performed by the distracted driving determination apparatus 2. The procedure described below is a mere example, and each of its processes may be modified. In the procedure described below, steps may be eliminated, substituted, or added as appropriate.

As described above, the first obtaining unit 2101 obtains the first detection information indicating the gaze or face orientation of the driver (step S101).

As described above, the determiner 2102 obtains the determination condition for detecting distracted driving (step S102).

As described above, the determiner 2102 determines whether the driver is engaging in distracted driving based on the first detection information indicating the gaze or face orientation of the driver and the determination condition (step S103). When the determiner 2102 determines that the driver is engaging in distracted driving (Yes in step S103), the output unit 2106 outputs an instruction signal (step S104) as described above.

The control unit 21 determines whether the distracted driving determination apparatus 2 is powered (step S105). When the distracted driving determination apparatus 2 is powered (Yes in step S105), the control unit 21 repeats the processing in step S101 and subsequent steps. The control unit 21 ends the distracted driving determination when the power supply to the distracted driving determination apparatus 2 is stopped (No in step S105).

Returning to step S103, when determining that the driver is not engaging in distracted driving (No in step S103), the control unit 21 performs the processing in step S105 as described above.

### Example of Determination Condition Change Operation

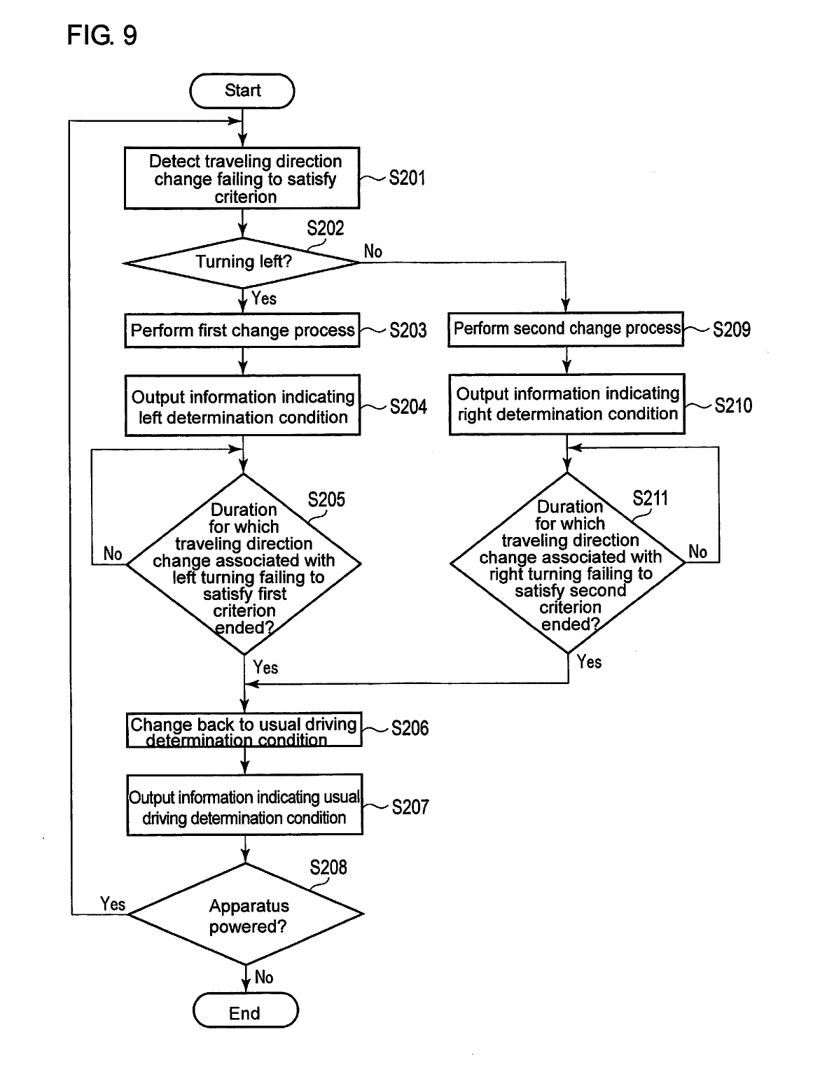

FIG. 9 is a flowchart showing an example operation for changing the determination condition performed by the distracted driving determination apparatus 2. The procedure described below is a mere example, and each of its processes may be modified. In the procedure described below, steps may be eliminated, substituted, or added as appropriate.

Based on the second detection information, the condition changer 2105 detects a change in the traveling direction of the vehicle 1 (step S201).

The condition changer 2105 determines whether a change in the traveling direction associated with left turning is detected (step S202).

When detecting a change in the traveling direction associated with left turning (Yes in step S202), the condition changer 2105 performs the first change process for the usual driving determination condition (step S203). In step S203, the condition changer 2105 may perform the first change process in accordance with the quantity of change in the traveling direction associated with left turning to relax the condition further. The condition changer 2105 determines to use the left determination condition, and outputs information indicating the left determination condition to the determiner 2102 (step S204).

The condition changer 2105 determines whether the end of the traveling direction change associated with left turning is being detected (step S205). When determining that the end of the traveling direction change associated with left turning is not detected (No in step S205), the condition changer 2105 continues the processing in step S205. The condition changer 2105 may repeat the processing in steps S203 through S205 to change the determination condition further in accordance with the quantity of change in the traveling direction associated with left turning. More specifically, the condition changer 2105 outputs information indicating a left determination condition corresponding to the quantity of change in the traveling direction associated with left turning upon every detection of an increase or a decrease in the quantity of change in the traveling direction associated with left turning.

In response to detection of the end of the traveling direction change associated with left turning, (Yes in step S205), the condition changer 2105 changes the determination condition from the left determination condition back to the usual driving determination condition (step S206). The condition changer 2105 determines to use the usual driving determination condition, and outputs information indicating the usual driving determination condition to the determiner 2102 (step S207).

The condition changer 2105 determines whether the distracted driving determination apparatus 2 is powered (step S208). When the distracted driving determination apparatus 2 is powered (Yes in step S208), the condition changer 2105 repeats the processing in step S201 and subsequent steps. The condition changer 2105 ends the distracted driving determination when the power supply to the distracted driving determination apparatus 2 is stopped (No in step S208).

Returning to step S202, when detecting no change in the traveling direction associated with left turning (No in step S202), the condition changer 2105 determines that a change in the traveling direction associated with right turning is detected. The condition changer 2105 performs the second change process for the usual driving determination condition (step S209). In step S209, the condition changer 2105 may perform the second change process in accordance with the quantity of change in the traveling direction associated with right turning to change the determination condition further. The condition changer 2105 determines to use the right determination condition, and outputs information indicating the right determination condition to the determiner 2102 (step S210).

The condition changer 2105 determines whether the end of the traveling direction change associated with right turning is detected (step S211). When determining that the end of the traveling direction change associated with right turning is not detected (No in step S211), the condition changer 2105 continues the processing in step S211. The condition changer 2105 may repeat the processing in steps S209 through S211 to change the determination condition further in accordance with the quantity of change in the traveling direction associated with right turning. More specifically, the condition changer 2105 outputs information indicating a right determination condition corresponding to the quantity of change in the traveling direction associated with right turning upon every detection of an increase or a decrease in the quantity of change in the traveling direction associated with right turning.

In response to detection of the end of the traveling direction change associated with right turning, (Yes in step S211), the condition changer 2105 changes the determination condition from the right determination condition back to the usual driving determination condition (step S206). The condition changer 2105 performs the processing in steps S207 and S208 as described above.

With the determination condition changing operation performed by the condition changer 2105 described above, the determiner 2102 can determine whether the driver is engaging in distracted driving using various determination conditions as described below. The determiner 2102 determines whether the driver is engaging in distracted driving using the usual driving determination condition in the duration for which the change in the traveling direction of the vehicle 1 is satisfying the criterion. The determiner 2102 determines whether the driver is engaging in distracted driving using the left determination condition in the duration for which the change in the traveling direction associated with left turning is being detected. The determiner 2102 determines whether the driver is engaging in distracted driving using the right determination condition in the duration for which the change in the traveling direction associated with right turning is being detected.

### Other Example of Determination Condition Change Operation

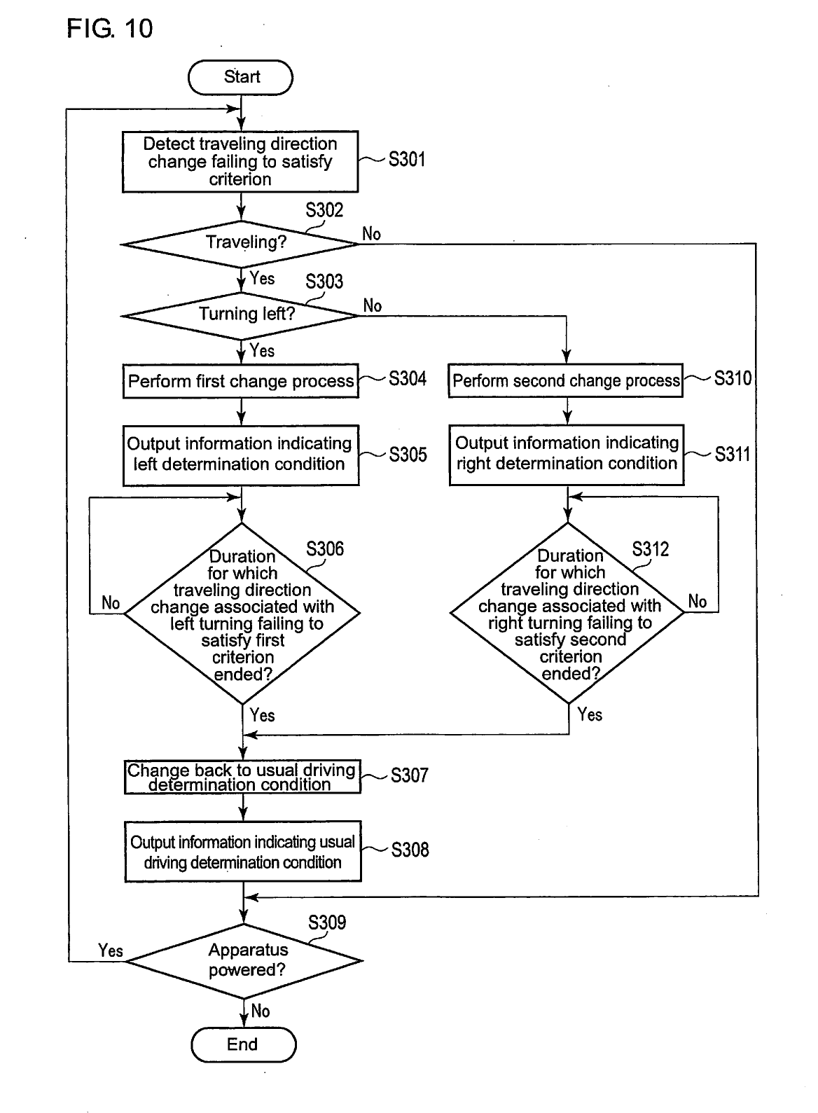

FIG. 10 is a flowchart showing another example operation for changing the determination condition performed by the distracted driving determination apparatus 2. The procedure described below is a mere example, and each of its processes may be modified. In the procedure described below, steps may be eliminated, substituted, or added as appropriate.

Based on the second detection information, the condition changer 2105 detects a change in the traveling direction of the vehicle 1, or for example, a change from the straight traveling direction to right or left (step S301).

As described above, the condition changer 2105 determines whether the vehicle 1 is traveling (step S302).

When the vehicle 1 is traveling (Yes in step S302), the condition changer 2105 performs the processing in steps S303 through S312. The processing in steps S303 through S312 is the same as the processing in steps S202 through S211 shown in FIG. 9, and will not be described.

When the vehicle 1 is not traveling (No in step S302), the condition changer 2105 determines that the vehicle 1 is stopped, and performs the processing in step S309.

With the determination condition changing operation performed by the condition changer 2105 described above, the determiner 2102 can determine whether the driver is engaging in distracted driving using various determination conditions as described below. The determiner 2102 determines whether the driver is engaging in distracted driving using the usual driving determination condition in the duration for which the vehicle 1 is determined to be traveling substantially straight. The determiner 2102 determines whether the driver is engaging in distracted driving using the left determination condition in the duration for which a change in the traveling direction associated with left turning is being detected during traveling of the vehicle 1. The determiner 2102 determines whether the driver is engaging in distracted driving using the right determination condition in the duration for which a change in the traveling direction associated with right turning is being detected during traveling of the vehicle 1.

In contrast, when determining that the vehicle 1 is stopped, the determiner 2102 does not use the left determination condition irrespective of the duration for which a change in the traveling direction associated with left turning is being detected. The determiner 2102 may use the usual driving condition or another condition for the stopped vehicle 1 different from the usual driving condition. Similarly, when determining that the vehicle 1 is stopped, the determiner 2102 does not use the right determination condition irrespective of the duration for which a change in the traveling direction associated with right turning is being detected. The determiner 2102 may use the usual driving condition or the condition for the stopped vehicle 1.

### Support Apparatus

### Support Operation for Driver

A support operation for the driver performed by the navigation apparatus 12, which is an example of the support apparatus, will be described first. The navigation apparatus 12 receives an instruction signal from the distracted driving determination apparatus 2. In response to the instruction signal, the navigation apparatus 12 displays an alert for the driver about distracted driving using an image or a video on the display 121.

A support operation for the driver performed by the sound output apparatus 13, which is an example of the support providing apparatus, will now be described. The sound output apparatus 13 receives an instruction signal from the distracted driving determination apparatus 2. In response to the instruction signal, the sound output apparatus 13 outputs an alert for the driver about distracted driving using a sound from the speaker 131. An alert may be in any form that can notify the driver of his or her distracted driving or of the need to look at the front of the vehicle 1.

The driver receives the support operation from the support apparatus. This allows the driver to notice his or her distracted driving and refocus on driving the vehicle 1.

### 4. Advantages and Effects

In the present embodiment described above, the distracted driving determination apparatus 2 changes a determination condition for detecting distracted driving to a value with which distracted driving is further less likely to be detected and uses the value in the duration for which a change in the traveling direction of the vehicle 1 is being detected.

As described below, the distracted driving determination apparatus 2 reduces determination in which the driver's action of checking to the right or left is determined to be distracted driving in the duration for which a change in the traveling direction to the right or left is being detected. When, for example, the driver changes the traveling direction of the vehicle 1 to turn right or left, change the lane, or pull over to the side of a road, the driver is likely to direct his or her gaze or face rightward or leftward. The distracted driving determination apparatus 2 reduces determination in which the driver's action of such checking to the right or left is determined to be distracted driving in the duration for which a change in the traveling direction to the right or left is being detected.

In the present embodiment, the distracted driving determination apparatus 2 further changes the determination condition for detecting distracted driving for the left of the vehicle 1 to a value with which distracted driving of the driver is further less likely to be detected and uses the value in the duration for which a change in the traveling direction associated with left turning is being detected. The distracted driving determination apparatus 2 changes the determination condition for detecting distracted driving for the right of the vehicle 1 to a value with which distracted driving of the driver is further less likely to be detected and uses the value in the duration for which a change in the traveling direction associated with right turning is being detected.

As described below, the distracted driving determination apparatus 2 thus reduces determination in which the driver's action of checking to the left is determined to be distracted driving in the duration for which the change in the traveling direction associated with left turning is being detected. When, for example, the driver is changing the traveling direction of the vehicle 1 leftward, the driver is likely to direct his or her gaze or face to the left of the vehicle 1. The distracted driving determination apparatus 2 reduces determination in which the driver's action of such checking is determined to be distracted driving in the duration for which the change in the traveling direction associated with left turning is being detected. As described below, the distracted driving determination apparatus 2 thus reduces determination in which the driver's action of checking to the right is determined to be distracted driving in the duration for which the change in the traveling direction associated with right turning is being detected. When, for example, the driver is changing the traveling direction of the vehicle 1 rightward, the driver is likely to direct his or her gaze or face to the right of the vehicle 1. The distracted driving determination apparatus 2 reduces determination in which the driver's action of such checking is determined to be distracted driving in the duration for which the change in the traveling direction associated with right turning is being detected.

In the present embodiment, the distracted driving determination apparatus 2 further performs the first change process in response to detection of a change associated with the left turning, and performs the second change process in response to detection of a change associated with right turning.

As described below, the distracted driving determination apparatus 2 thus reduces, by performing the first change process, determination in which the driver's action of checking to the left of the vehicle 1 is determined to be distracted driving in the duration for which the change in the traveling direction associated with left turning is being detected. When, for example, the driver is changing the traveling direction of the vehicle 1 leftward, the driver is likely to direct his or her gaze or face to the left of the vehicle 1. The distracted driving determination apparatus 2 reduces determination in which the driver's action of such checking is determined to be distracted driving in the duration for which the change in the traveling direction associated with left turning is being detected. As described below, the distracted driving determination apparatus 2 thus reduces, by performing the second change process, determination in which the driver's action of checking to the right of the vehicle 1 is determined to be distracted driving in the duration for which the change in the traveling direction associated with right turning is being detected. When, for example, the driver is changing the traveling direction of the vehicle 1 rightward, the driver is likely to direct his or her gaze or face to the right of the vehicle 1. The distracted driving determination apparatus 2 reduces determination in which the driver's action of such checking is determined to be distracted driving in the duration for which the change in the traveling direction associated with right turning is being detected.

In the present embodiment, the distracted driving determination apparatus 2 further increases the shift of the boundary position between the first and second areas A1 and A2 in accordance with the quantity of change in the traveling direction associated with left turning. The distracted driving determination apparatus 2 further increases the shift of the boundary position between the first and third areas A1 and A3 in accordance with the quantity of change in the traveling direction associated with right turning.

As described below, the distracted driving determination apparatus 2 thus reduces determination in which the driver's action of checking to the left of the vehicle 1 is determined to be distracted driving by increasing the shift of the boundary position between the first and second areas A1 and A2 in accordance with the quantity of change in the traveling direction associated with left turning. For example, as the driver changes the traveling direction of the vehicle 1 leftward greatly, the driver is likely to direct his or her gaze or face to the left rear rather than to the left front of the vehicle 1. The distracted driving determination apparatus 2 reduces determination in which the driver's action of such checking is determined to be distracted driving in the duration for which the change in the traveling direction associated with left turning is being detected. As described below, the distracted driving determination apparatus 2 reduces determination in which the driver's action of checking to the right of the vehicle 1 is determined to be distracted driving by increasing the shift of the boundary position between the first and third areas A1 and A3 in accordance with the quantity of change in the traveling direction associated with right turning. For example, as the driver changes the traveling direction of the vehicle 1 rightward greatly, the driver is likely to direct his or her gaze or face to the right rear rather than the right front of the vehicle 1. The distracted driving determination apparatus 2 reduces determination in which the driver's action of such checking is determined to be distracted driving in the duration for which the change in the traveling direction associated with right turning is being detected.

In the present embodiment, the distracted driving determination apparatus 2 further disables the first change process and the second change process when the vehicle 1 is stopped.

As described below, when the vehicle 1 is stopped, the distracted driving determination apparatus 2 correctly determines whether the driver is engaging in distracted driving irrespective of the duration for which a change in the traveling direction of the vehicle 1 to the right or left is being detected. For example, when the vehicle 1 is stopped with its traveling direction being changed rightward or leftward with respect to the straight traveling direction to wait for, for example, pedestrians to cross the road or for a traffic signal to change, the driver may desirably direct his or her gaze or face forward rather than rightward or leftward from the vehicle 1. Under such situations, the distracted driving determination apparatus 2 disables the change to the determination condition for the left or the right of the vehicle 1 to correctly determine whether the driver is engaging in distracted driving.

### 5. Modifications

5.1

Although the distracted driving determination apparatus 2 detects a change in the traveling direction of the vehicle 1 with respect to the straight traveling direction based on detection information indicating the steering angle from the steering sensor 8B in the present embodiment, the embodiment is not limited to this structure. The distracted driving determination apparatus 2 may detect a change in the traveling direction of the vehicle 1 with respect to the straight traveling direction based on detection information from various sensors, such as detection information indicating the angle of the tire or the quantity of behavior of the vehicle 1 obtained from the gyro sensor 8H.

In the present embodiment, the angle of the area defined for the left of the vehicle 1 or the gaze retention allowable duration for the area is changed when the vehicle is determined to be traveling leftward. The angle of the area defined for the right of the vehicle 1 or the gaze retention allowable duration for the area is changed when the vehicle is determined to be traveling rightward. However, the embodiment is not limited to this structure. In some embodiments, when the vehicle is determined to be traveling leftward, the angle of the area defined for the right of the vehicle 1 or the gaze retention allowable duration for the area may also be changed, in addition to the angle or the duration defined for the left of the vehicle. Further, when the vehicle is determined to be traveling rightward, the angle of the area defined for the left of the vehicle 1 or the gaze retention allowable duration for the area may also be changed, in addition to the angle or the duration defined for the right of the vehicle.

When changing the traveling direction of the vehicle rightward or leftward, the driver typically checks the safety of both the right and left of the vehicle, in addition to the direction in which the vehicle is turning. The distracted driving determination apparatus with the above structure enables appropriate distracted driving determination reflecting the actual driving state when the driver is checking the right or left of the vehicle.

5.2

The present invention is not limited to the present embodiment, but the components may be modified without departing from the spirit and scope of the invention. The components described in the present embodiment may be combined as appropriate to provide various aspects of the invention. For example, some of the components described in the present embodiment may be eliminated. Further, components in different embodiments may be combined as appropriate.

### 6. Appendix

The present embodiment may be partially or entirely expressed in, but not limited to, the following forms shown in the appendix below in addition to the claims.

### APPENDIX 1

A distracted driving determination apparatus mounted on a vehicle (1), the apparatus comprising a hardware processor (211) configured to

obtain first detection information indicating a gaze or a face orientation of a driver (2101);

determine whether the driver is engaging in distracted driving based on the gaze or the face orientation of the driver indicated by the first detection information and a determination condition for detecting distracted driving (2102);

obtain second detection information indicating a change in a traveling direction of the vehicle (1) with respect to a straight traveling direction of the vehicle (1) (2103);

determine whether the vehicle (1) is traveling straight or traveling rightward or leftward based on the second detection information (2105); and

set the determination condition to a first determination condition when the vehicle (1) is determined to be traveling straight based on a determination result from the second determiner, and to a second determination condition different from the first determination condition when the vehicle (1) is determined to be traveling rightward or leftward based on the determination result from the second determiner (2105).

### APPENDIX 2

A distracted driving determination apparatus mounted on a vehicle (1), the apparatus comprising a hardware processor (211) configured to

obtain first information indicating a gaze or a face orientation of a driver (2101);

obtain second information indicating a traveling direction of the vehicle (1) (2103); and

determine distracted driving by comparing the gaze or the face orientation indicated by the first information with a predetermined criterion indicating a direction or a duration (2102),

wherein the hardware processor (211) is further configured to change the criterion in accordance with the traveling direction indicated by the second information (2105).

### APPENDIX 3

A distracted driving determination method performed by a distracted driving determination apparatus mounted on a vehicle (1), the method comprising:

obtaining, with at least one hardware processor (211), first detection information indicating a gaze or a face orientation of a driver (S101);

determining, with at least one hardware processor (211), whether the driver is engaging in distracted driving based on the gaze or the face orientation of the driver indicated by the first detection information and a determination condition for detecting distracted driving (S103);

obtaining, with at least one hardware processor (211), second detection information indicating a change in a traveling direction of the vehicle (1) with respect to a straight traveling direction of the vehicle (1) (S201);

determining, with at least one hardware processor (211), whether the vehicle (1) is traveling straight or traveling rightward or leftward based on the second detection information (S202);

setting, with at least one hardware processor (211), the determination condition to a first determination condition when the vehicle (1) is determined to be traveling straight; and

setting, with at least one hardware processor (211), the determination condition to a second determination condition different from the first determination condition when the vehicle (1) is determined to be traveling rightward or leftward (S202 to S211).

### APPENDIX 4

A distracted driving determination method performed by a distracted driving determination apparatus mounted on a vehicle (1), the method comprising:

obtaining, with at least one hardware processor (211), first information indicating a gaze or a face orientation of a driver (S101);

obtaining, with at least one hardware processor (211), second information indicating a traveling direction of the vehicle (1) (S201); and

determining, with at least one hardware processor (211), distracted driving by comparing the gaze or the face orientation indicated by the first information with a predetermined criterion indicating a direction or a duration (S103),

wherein the determining distracted driving includes changing the criterion in accordance with the traveling direction indicated by the second information (S202 to S211).

1. A distracted driving determination apparatus, comprising:
a first obtaining unit configured to obtain first detection information indicating a gaze or a face orientation of a driver;
a first determiner configured to determine whether the driver is engaging in distracted driving based on the gaze or the face orientation of the driver indicated by the first detection information and a determination condition for detecting distracted driving;
a second obtaining unit configured to obtain second detection information indicating a change in a traveling direction of a vehicle with respect to a straight traveling direction of the vehicle;
a second determiner configured to determine whether the vehicle is traveling straight or traveling rightward or leftward based on the second detection information; and
a condition changer configured to set the determination condition to a first determination condition when the vehicle is determined to be traveling straight based on a determination result from the second determiner, and to a second determination condition different from the first determination condition when the vehicle is determined to be traveling rightward or leftward based on the determination result from the second determiner.

2. The distracted driving determination apparatus according to claim 1, wherein
the second determination condition is set to a different value between when the vehicle is determined to be traveling rightward based on the determination result from the second determiner and when the vehicle is determined to be traveling leftward based on the determination result from the second determiner.

3. The distracted driving determination apparatus according to claim 1, wherein
the condition changer defines, as the first determination condition, a first area that is an imaginary area ranging toward a front of the vehicle at a first angle and a second area that is an imaginary area adjacent to the first area and ranging toward a right or left of the vehicle at a second angle, and
defines, as the second determination condition, a third area that is an imaginary area ranging toward the front of the vehicle at a third angle greater than the first angle and a fourth area that is an imaginary area adjacent to the first area and ranging toward the right or left of the vehicle at a fourth angle smaller than the second angle, and
the first determiner determines that the driver is not engaging in distracted driving when the gaze or the face orientation of the driver is within the first area or the third area, and
determines that the driver is engaging in distracted driving when the gaze or the face orientation of the driver is within the second area or the fourth area.

4. The distracted driving determination apparatus according to claim 3, wherein
the condition changer sets the third angle to a greater value and sets the fourth angle to a smaller value as a quantity of change in the traveling direction of the vehicle obtained from the second obtaining unit increases.

5. The distracted driving determination apparatus according to claim 1, wherein
the condition changer defines a distracted driving determination area that is an imaginary area defined at the right or the left of the vehicle for determining distracted driving,
sets, as the first determination condition, a first duration for which the gaze or the face orientation of the driver is allowed to be within the distracted driving determination area, and
sets, as the second determination condition, a second duration longer than the first duration, and
the first determiner determines that the driver is not engaging in distracted driving when the gaze or the face orientation of the driver is continuously within the distracted driving determination area for a duration less than or equal to the first duration or the second duration, and
determines that the driver is engaging in distracted driving when the gaze or the face orientation of the driver continuously is within the distracted driving determination area for a duration exceeding the first duration or the second duration.

6. The distracted driving determination apparatus according to claim 5, wherein
the condition changer sets the second duration to a greater value as the quantity of change in the traveling direction of the vehicle obtained from the second obtaining unit increases.

7. The distracted driving determination apparatus according to claim 1, further comprising:
a third obtaining unit configured to obtain third detection information indicating a traveling state of the vehicle; and
a fourth determiner configured to determine whether the vehicle is at a speed greater than or equal to a predetermined speed at which the vehicle is determined to be traveling or at a speed less than the predetermined speed at which the vehicle is determined as being stopped,
wherein the condition changer sets the determination condition to the first determination condition when the vehicle is determined as being stopped based on a determination result from the fourth determiner irrespective of whether the vehicle is determined to be traveling rightward or leftward.

8. The distracted driving determination apparatus according to claim 1, further comprising:
an output unit configured to output an instruction signal to a support apparatus to support the driver when the first determiner determines that the driver is engaging in distracted driving.

9. A distracted driving determination apparatus, comprising:
a first obtaining unit configured to obtain first information indicating a gaze or a face orientation of a driver;
a second obtaining unit configured to obtain second information indicating a traveling direction of a vehicle; and
a determiner configured to determine distracted driving by comparing the gaze or the face orientation indicated by the first information with a predetermined criterion indicating a direction or a duration,
wherein the determiner changes the criterion in accordance with the traveling direction indicated by the second information.

10. A distracted driving determination method performed by a distracted driving determination apparatus mounted on a vehicle, the method comprising:
obtaining, with the distracted driving determination apparatus, first information indicating a gaze or a face orientation of a driver;
obtaining, with the distracted driving determination apparatus, second information indicating a traveling direction of the vehicle; and
determining, with the distracted driving determination apparatus, distracted driving by comparing the gaze or the face orientation indicated by the first information with a predetermined criterion indicating a direction or a duration,
wherein the determining distracted driving includes changing the criterion in accordance with the traveling direction indicated by the second information.

11. A distracted driving determination method performed by a distracted driving determination apparatus mounted on a vehicle, the method comprising:
obtaining, with the distracted driving determination apparatus, first detection information indicating a gaze or a face orientation of a driver;
determining, with the distracted driving determination apparatus, whether the driver is engaging in distracted driving based on the gaze or the face orientation of the driver indicated by the first detection information and a determination condition for detecting distracted driving;
obtaining, with the distracted driving determination apparatus, second detection information indicating a change in a traveling direction of the vehicle with respect to a straight traveling direction of the vehicle;
determining, with the distracted driving determination apparatus, whether the vehicle is traveling straight or traveling rightward or leftward based on the second detection information;
setting, with the distracted driving determination apparatus, the determination condition to a first determination condition when the vehicle is determined to be traveling straight; and
setting, with the distracted driving determination apparatus, the determination condition to a second determination condition different from the first determination condition when the vehicle is determined to be traveling rightward or leftward.

12. A non-transitory computer-readable medium storing a program for determining distracted driving, the program causing a computer to implement processes performed by the units included in the distracted driving determination apparatus according to claim 1.
